(19) United States
(12) Patent Application Publication
(10) Pub. No.: US 2019/0041131 A1
(43) Pub. Date: Feb. 7, 2019

(54) PRODUCE DRYER DISTRIBUTION SYSTEM

(71) Applicant: Taylor Fresh Foods, Inc., Salinas, CA (US)

(72) Inventors: Douglas BUCK, Salinas, CA (US); David Marc ZURLINDEN, Monterey, CA (US)

(21) Appl. No.: 16/052,928

(22) Filed: Aug. 2, 2018

Related U.S. Application Data
(60) Provisional application No. 62/541,558, filed on Aug. 4, 2017.

(51) Int. Cl. F26B 1/00; F26B 25/00

(52) U.S. Cl. CPC F26B 1/00; F26B 25/00

(57) ABSTRACT

Embodiments for implementing a produce dryer system, method, and apparatus are provided. For example, a produce dryer system may include a pickup station comprising a bin configured to be contain produce that is designated for drying, a first dryer and a second dryer configured to receive the bin and dry the produce in the bin by running for a dryer cycle associated with the produce, and a transport device. The transport device may include a ground transport chassis configured to travel along a predetermined path, a driven arm attached to the ground transport chassis that is configured to pick up and set down the bin, and a controller configured to determine which of the first dryer and the second dryer to use for drying the produce in the bin and for positioning and removing the bin from the first dryer or second dryer with the transport device.

### CLAIM OF PRIORITY UNDER 35 U.S.C. § 119

The present application for patent claims benefit of U.S. Provisional Patent Application Ser. No. 62/541,558, filed Aug. 4, 2017, assigned to the assignee hereof and hereby expressly incorporated by reference herein.

### BACKGROUND

### Field of the Disclosure

Certain aspects of the present disclosure generally relate to a dryer system and more specifically to a produce dryer system that incorporates a number of design elements.

### Description of the Related Art

Processing produce can entail a complex and burdensome process of balancing the need to efficiently harvest, cut, clean, package, and transport produce while also providing a controlled and gentle handling of the produce to avoid damage and contamination. Controlled and gentle handling is helpful to implement during all steps of produce processing such as during the steps of inspection, sizing, cleaning, and packaging of the produce. Further, the safety, cost, and the efficiency of processing large volumes of produce are other considerations that should be taken into account when designing and implementing processing systems and operations.

Currently, drying of the produce can be done using a number of different devices such as industrial dryers, dryer bins, drying racks, drying conveyors, fans, and other system and devices. The drying of produce using industrial dryers typically includes a system of ropes and pulleys that lift and move the dryer bins into the dryers and also move the bins and produce to an exit point of the system such as a hopper. However, the current systems do not effectively address all the above considerations.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Certain aspects of the present disclosure provide a produce dryer system including a pickup station comprising a bin configured to contain produce that is designated for drying, a first dryer, and a second dryer configured to receive the bin and dry the produce in the bin by running for a dryer cycle associated with the produce; and a transport device. The transport device includes a ground transport chassis configured to travel along a predetermined path, a driven arm attached to the ground transport chassis that is configured to pick up and set down the bin; and a controller configured to determine which of the first dryer and the second dryer to use for drying the produce in the bin and for positioning and removing the bin from the first dryer or second dryer with the transport device.

Certain aspects of the present disclosure provide a produce bin transport device that includes a ground transport chassis configured to travel along a predetermined path from a bin pickup station to a produce hopper with one or more dryers there between, a driven arm attached to the chassis and configured to pick up and set down a bin that contains produce, and a controller configured to determine when to pick up the bin, when to set down the bin, where to move the chassis, and where to move the driven arm. The produce bin transport device is configured to move the bin from the pickup station to a dryer from the one or more dryers, and from the dryer to the produce hopper.

Certain aspects of the present disclosure provide a method of operating a produce dryer system. The method includes moving a transport device along a predetermined ground path to a pickup station, picking up a produce bin from the pickup station with the transport device using a driven arm of the transport device that is attached to a chassis, moving the produce pin along the predetermined path to a dryer with the transport device, and positioning the produce bin into a dryer with the transport device.

Numerous other aspects are provided including methods, apparatus, systems, computer program products, and processing systems. To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF DRAWINGS

FIG. 1 illustrates a block diagram of a produce dryer system and product flow in the produce dryer system, in accordance with certain aspects of the present disclosure.

FIG. 2 illustrates a block diagram of a produce dryer system and communication capabilities in the produce dryer system, in accordance with certain aspects of the present disclosure.

FIG. 3 illustrates a block diagram of a produce dryer system that includes sensors and a programmable logic controller, in accordance with certain aspects of the present disclosure.

FIG. 4 illustrates a schematic diagram of a produce wash system with at least two dryers, in accordance with certain aspects of the present disclosure.

FIG. 5 illustrates a schematic diagram of a produce wash system with a plurality of dryers in accordance with certain aspects of the present disclosure.

FIG. 6 illustrates a schematic diagram of a produce wash system with one or more sensors in accordance with certain aspects of the present disclosure.

FIG. 7 illustrates a schematic diagram of a produce wash system with a variable vehicle path in accordance with certain aspects of the present disclosure.

FIG. 8 illustrates a schematic diagram of a produce wash system with another variable vehicle path in accordance with certain aspects of the present disclosure.

FIG. 9 illustrates a top view of a produce dryer system including a plurality of features in accordance with certain aspects of the present disclosure.

FIG. 10 illustrates a top view of a produce dryer system including additional conveyers and other features in accordance with certain aspects of the present disclosure.

FIG. 11 illustrates a top perspective view of a produce dryer system including a plurality of features in accordance with certain aspects of the present disclosure.

FIG. 12 illustrates a top perspective view of a produce dryer system including a vehicle track in accordance with certain aspects of the present disclosure.

FIG. 13 illustrates a top perspective view of a produce dryer system including a gated interlock system in accordance with certain aspects of the present disclosure.

FIG. 14 illustrates a side perspective view of a produce dryer system including power cabling in accordance with certain aspects of the present disclosure.

FIG. 15 illustrates a side perspective view of a produce dryer system including a programmable logic controller (PLC) that includes a human machine interface (HMI) in accordance with certain aspects of the present disclosure.

FIG. 16 illustrates a flow chart of a method of operating a produce dryer system in accordance with certain aspects of the present disclosure.

FIG. 17 illustrates a top view of a produce dryer system including a plurality of feature including a bin receiver in accordance with certain aspects of the present disclosure.

FIG. 18 illustrates a top view of a produce dryer system including a plurality of features in accordance with certain aspects of the present disclosure.

To facilitate understanding, identical reference numerals have been used, where possible, to designate identical elements that are common to the figures. It is contemplated that elements described in one case may be beneficially utilized on other embodiments without specific recitation. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. The scope is defined not by the detailed description but by the appended claims. Like numerals denote like elements throughout.

Although the terms used herein are generic terms which are currently widely used and are selected by taking into consideration functions thereof, the meanings of the terms may vary according to the intentions of persons skilled in the art, legal precedents, or the emergence of new technologies. Furthermore, some specific terms may be randomly selected by the applicant, in which case the meanings of the terms may be specifically defined in the description. Thus, the terms should be defined not by simple appellations thereof but based on the meanings thereof and the context of the description. As used herein, expressions such as “at least one of,” when preceding a list of elements, modify the entire list of elements and do not modify the individual elements of the list.

It will be understood that when the terms “includes,” “comprises,” “including,” and/or “comprising,” when used in this specification, specify the presence of stated elements and/or components, but do not preclude the presence or addition of one or more elements and/or components thereof. As used herein, the term “module” refers to a unit that can perform at least one function or operation and may be implemented utilizing any form of hardware, software, or a combination thereof.

One or more embodiments of the present disclosure relate generally to a produce dryer system that can include one or more of a number of novel improvements. For example, the dryer system can include one or more of a transport device that includes a chassis (e.g., a ground transport chassis) that travels along the ground and a driven arm, a pickup station, a plurality of dryers, a hopper, a bin conveyer, and a controller any one of which is novel and provides benefit and advantages over the current state of the art.

For example, according to one or more embodiments, a produce dryer system includes a pickup station that has at least one bin that is designated for drying, for example, a bin that may be filled with produce that is wet. The system also includes a transport device. The transport device includes a chassis that travels along the ground on a predetermined path (e.g., predetermined ground path), a driven arm attached to the chassis that is configured to pick up and set down the at least one bin, and a controller that determines when to pick up the bin, when to set down the bin, where to move the chassis, and where to move the driven arm. The system can further include a first dryer configured to receive the bin from the transport device and dry the produce in the bin by running for a dryer cycle associated with the produce and a second dryer configured to receive the bin from the transport device and dry the produce in the bin by running for the dryer cycle associated with the produce. The system further is configured such that the controller of the transport device determines which of the first dryer and the second dryer to use based on collected system information. Finally, the system can also include a hopper configured to receive the produce content from the bin.

Turning now to the figures, a number of different embodiments that include one or more novel features are provided herewith.

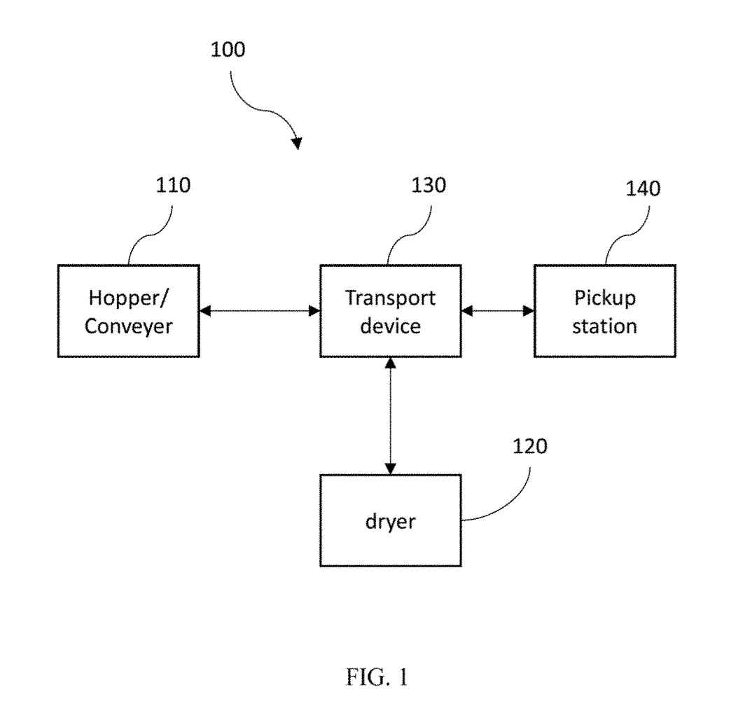

FIG. 1 illustrates a block diagram of a produce dryer system 100 and product flow in the produce dryer system 100 in accordance with one or more embodiments. As shown, the produce dryer system includes a pickup station 140, a transport device 130, at least one dryer 120, and a hopper and/or conveyer 110. The product that flows between the pickup station 140, the transport device 130, the at least one dryer 120, and the hopper and/or conveyer 110 can include fresh produce and other food products. The product can be a single type of fresh produce and/or food product or can be a combination of one or more food ingredients.

In accordance with one or more embodiments, the product enters the system through the pickup station 140 such that the product is provided in drying bins that are placed in a queue within the pickup station 140. The transport device 130 can then travel to a position adjacent to or within the pickup station 140. The transport device 130 then selects and picks up a bin that contains wet product/produce. The transport device 130 then selects the dryer 120 based on system collected information and proceeds to move along the ground toward the dryer 120. The transport device 130 can then place the bin into the dryer 120 and the dryer will proceed to operate a dryer cycle. Once the dryer cycle is complete the transport device 130 will receive a communication from the dryer 120 or a central controller indicating to the transport device 130 that the bin had completed the drying processes in the dryer 120 and is ready to be moved. The transport device 130 will then travel back to the dryer 120, pick up the dryer bin with what is now dry product contained therein, and then move to the hopper/conveyer 110. At the hopper/conveyer 110, the transport device 130 deposits the dry product into/onto the hopper/conveyer 110. Additionally, in accordance with one or more embodiments, the transport device 130 may additionally place the bin on a bin return conveyer or return the bin to another designated area or station. According to another case, the pickup station 140 can also function as a drop off station for empty bins.

According to one or more embodiments, the pickup station 140 can be a conveyer that moves a plurality of dryer bins that are filled with wet product. The conveyer can be wide enough for a single bin or multiple bins. In another case, the pickup station 140 can be a designated area where dryer bins are deposited by other means within the processing plant. The pickup station 140 can be created in the form of a platform or simply by markings on the ground. According to other embodiments, the pickup station 140 can be any location or group of locations, that the transport device 130 can travel to within the plant to pick up the wet product such as, for example, at the end of a produce wash system line.

According to one or more embodiments, the dryer can be any type of industrial dryer. Further, according to other embodiments, the produce dryer system 100 may include a plurality of dryers. The plurality of dryers can all be of the same type or can be a combination of different dryers. According to another case, each dryer can be controlled such that the dryer setting can be set for particular product type. Additionally, each dryer can be controlled for the specific dryer bin being loaded by the transport device 130.

According to one or more embodiments, the hopper 110 is a product collection bin. According to other embodiments, the hopper 110 can be a conveyer that moves the deposited product along toward packaging systems within the processing plant. According to other embodiments, the hopper 110 can have a plurality of conveyers and deposition bins. Further, according to another case, the hopper 110 can be a movable hopper than is transported to the next processing step once it has a requisite amount of product loaded.

According to one or more embodiments, the transport device 130 is a vehicle that travels along a predetermined path or paths that lead from one system element to the other system elements. According to one or more embodiments, the transport device 130 includes a chassis and a driven arm attached to the chassis. The arm is configured with a clamping mechanism that is able to pick up and set down at least one bin at a time. The arm is also able to lift and lower the bin as well as swing, swivel and tilt the bin as needed. For example, the transport device 130 can use its arm to pick up a bin then rotate the arm around to line up the bin with a dryer 120, lift the bin up and then lower the bin down into the dryer. The transport device 130 can then pick up the bin again after a drying cycle is completed and can move the bin such that it can be tilted over a hopper 110 into which the contents of the bin can be deposited. This can be done by rotating the bin such that the opening is turned from facing upward to facing downward. Further, the transport device 130 can then rotate and move the bin to a return conveyer were the arm is able to move to set down the bin on the conveyer then release the bin.

According to one or more embodiments, the transport device 130 also includes a propulsion system. For example, the propulsion system can include an electric motor that is connected to the chassis and a rolling portion powered by the electric motor. The rolling portion can be selected from a plurality of wheels, one or more slide pads, one or more magnetic propulsion pads, and/or a continuous track system. The continuous track system can include a synthetic rubber track reinforced with steel set within the synthetic rubber track. According to other embodiments, the propulsion system can take on other forms such as external mechanical, electro-mechanical, driven, pneumatic, or any combination thereof, type drives that are generally anchored to the track system and/or floor and coupled to the transport device 130. Embodiments are not limited to these examples as other propulsion system(s) may be used in accordance with one or more embodiments disclosed herein to drive and guide. For example, in accordance with one or more embodiments, in a more sophisticated form, a propulsion system may be an autonomous vehicle.

According to one or more embodiments, the transport device 130 can also include one or more sensors that collect different forms of information relating to both the transport device properties as well as environmental properties and information about other elements in the system in proximity of the transport device 130 and at least one or more of the sensors' detection range. Further, the transport device 130 can include one or more processors or computing resources that can be configured to control the movements of the transport device 130. The processor and/or computing resources can be configured such that they process and generate the control signals on board the transport device 130 based on locally collected sensor information. The control signals can also be generated based on received information from other system devices and elements. Further, the control signals can be generated based on historical information stored locally or elsewhere. Further, the control signals can be based on user inputs or previously set instructions. In another case, the processor and/or other computing resources receive control signals from another source and are also configured to send that source the collected sensor information so that the control signals can be generated using at least the sensor data.

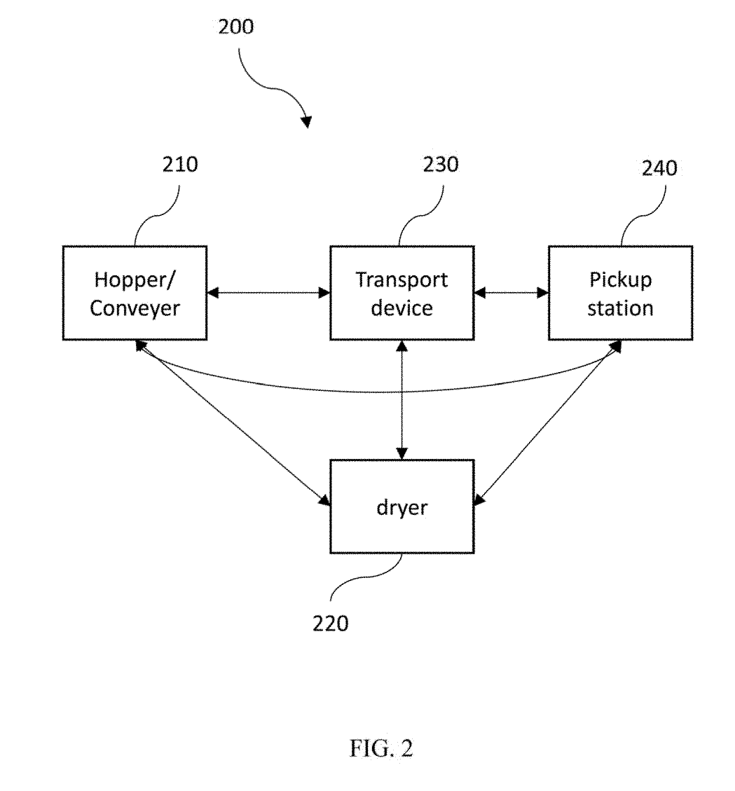

FIG. 2 illustrates a block diagram of a produce dryer system 200 and communication capabilities in the produce dryer system 200 in accordance with one or more embodiments. As shown, the produce dryer system 200 includes a pickup station 240, a transport device 230, a hopper and/or conveyer 210, and one or more dryers 220 which are similar to the corresponding elements of FIG. 1. Further, in accordance with one or more embodiments, each of the produce dryer system 200 elements are able to communicate with one another.

For example, the transport device 230 includes one or more sensors as well as a receiver and a transmitter. The transport device 230 can collect information about the pickup station 240, hopper/conveyer 210, and one or more dryers 220 using the sensors as the transport device 230 travels between these elements of the system 200. For example, the transport device 230 can include a camera sensor that collected information about each of the other system elements that come into view of the camera. The transport device 230 can also include sensors that detect and collect information about the transport device 230 itself such as temperature, power consumption, component wear and tear, operating time, driven fluid level, noise levels, movement accuracy of driven arm, movement speed of overall device, load values based on selected bin, bin placement information, location information within the overall system, and other useful data. The transport device 230 can use its transmitter to provide one, some, or all of the collected data to any one or more of the other system 200 elements. For example, the transport device 230 can routinely broadcast its location to the other elements in the system 200.

The transport device 230 can receive using its receiver data collected and transmitted from any one or more of the other elements of the system 200. For example, the pickup station 240 can use one or more sensors to detect the bin count and location to generate a queue of bins that includes information about the specific location of each bin in the pickup station, the content of the bins, and the type of bin. The pickup station 240 can transmit this information to the transport device and to the other elements so that system wide action can be taken to account for that information. For example, the transport device 230 upon receiving information that a bin with wet produce is waiting at the pickup station can generate and queue up a control command to return to the pickup location 240 to retrieve that bin.

The dryer can receive that information from the pickup location 240 and adjust its settings to prepare itself to run a dryer cycle and can also generate a request signal that is sent to the transport device 230. The transport device can receive this request signal and then add the next control command to then take the bin to that dryer. Alternatively, the dryer can simply let the transport device 230 know its availability schedule, and the transport device 230 can use that information to select a dryer to use next. Further, the dryer can also send information to the transport device about timing for completing the drying cycle which the transport device 230 can use to set up a collection schedule to return to that dryer to get the bin and transport the bin and its content to the hopper/conveyer 210. The transport device 230 can also communicate to the dryer information about when it is scheduled to arrive with a bin for drying or is scheduled to arrive to take a dried bin away, and the dryer can use this information to adjust dryer setting accordingly.

The pickup station 240 and the hopper/conveyer 210 can communicate with each other regarding, for example, overall content that can be used to determine if the overall in flow and out flow of this portion of the processing plant is going smoothly. If there is an issue such as an indication that the hopper is filling too quickly or that not enough wet bins are arriving to utilize the dryer and hopper system to capacity, that information can be reported outside the dryer system 200 to the processing plant that can use that information to adjust overall input or output flows before any loss in productivity or damage to product occurs. Other communications can also be included between each of the elements of the system 200 that facilitates the flow of wet product to dry product using the transport device 230 to facilitate the movement of the product from the pickup station 240 to the dryer 220 and then to the hopper/conveyer 210.

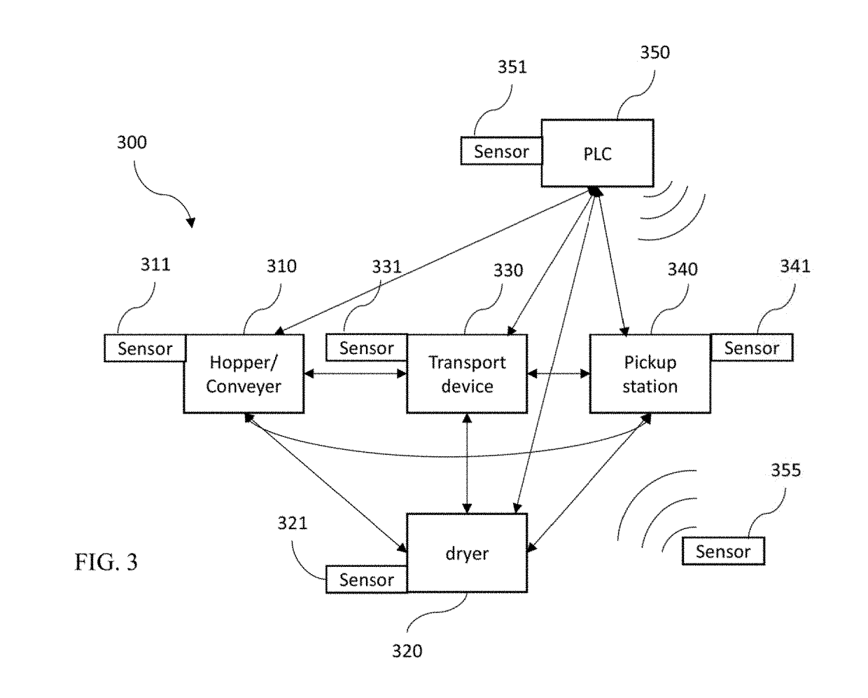

FIG. 3 illustrates a block diagram of a produce dryer system 300 that includes sensors and a programmable logic controller (PLC) 350 in accordance with one or more embodiments. Similar to FIGS. 1 and 2, the system 300 includes a pickup station 340, a transport device 330, one or more dryers 320, and a hopper/conveyer 310.

Further, the system 300 includes the PLC 350 that can communicate with each element of the system 300. The PLC 350 can communicate using wired and/or wireless means and can both receive and send a variety of communications including sensor data and generated control signals. The PLC 350 provides a centralized control center that can be placed at a location away from the working elements of the dryer system 300. The PLC 350 can also be physically embodied in a distributed case were the physical commuting elements are scattered amount the different elements of the system and/or provided in a separate case on and/or off site. In another case, the PLC 350 can be physically placed in or at any one of the other system elements such as the transport device.

Additionally, according to one or more embodiments, the system 300 includes a plurality of sensors distributed throughout the system as shown. For example, as shown in FIG. 3, the transport device 330 includes one or more sensors 331. The pickup station 340 includes one or more sensors 341. The one or more dryers include one or more sensors 321. The hopper/conveyer includes one or more sensors 311. The PLC 350 can include one or more sensors 351. Further, other independent sensors 355 can be included in the system 300. The sensors can be placed on, within, or in near proximity of the elements of the system 300. The sensors can include a variety of different sensor types including any one or more of a temperature sensor, a weight sensor, a radio-frequency identification (RFID) sensor, an image sensor, a video sensor, a sound sensor, an array of positioning sensors, a piezo electronic sensor, proximity, and infrared.

These sensors can provide system information that can be used by the PLC 350 to generate control signals for operating the system 300. For example, the PLC 350 can use the sensor data to track the location and scheduled path of the transport device 330. Further, the PLC 350 can track the drying progress of the one or more dryers 320 and the current product loads in the pickup station 340 and the hopper/conveyer 310. The PLC 350 can use all this collected sensor data to generate control signals for at least the transport device 330 so that the transport device 330 can efficiently move bins with product from the pickup station to dryers 320 and then to the hopper 310. In other cases, one or more of these sensors can be removed or additional sensors can be added at any one or more locations.

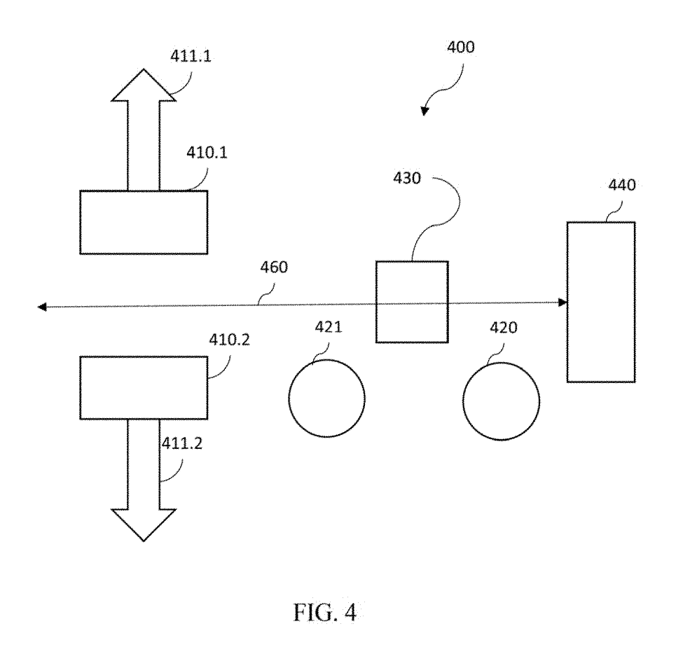

FIG. 4 illustrates a schematic diagram of a produce wash system 400 with at least two dryers 421 and 420 in accordance with one or more embodiments. The produce wash system 400 includes a pickup station 440, a transport device 430, a first dryer 420, a second dryer 421, a first hopper 410.1 and a second hopper 410.2.

The first hopper 410.1 includes a conveyer 411.1 that moves dried produce from the first hopper 410.1 out of the produce wash system 400 and toward another location in the processing plant such as packaging. Similarly, the second hopper 410.2 includes a second conveyer 411.2 that moves dried produce from the second hopper 410.2 out of the produce wash system 400 toward another location in the processing plant such as a second different packaging station. In other embodiments, only one set including a hopper and conveyer can be included in the system 400. In another case, only a hopper can be included in the system 400. Further, in another case, only one of the conveyers can be included in the system 400.

According to one or more embodiments, the system 400 includes a predetermined path 460 along which the transport device 430 travels. As shown the predetermined path 460 is a straight path that leads the transport device within close proximity of all the elements of the system 400 including both dryers 420 and 421. The transport device 430 can pick up a bin with wet produce from the pickup station 440 and then select one of the two dryers 420 and 421 based on which is available. For example, it is possible that although being closer, the dryer 420 may already have a bin drying so the transport device 430 will take the bin to the second dryer 421 which may be available.

In another case, both dryers may be drying bins wherein the dryer 421 is scheduled to complete drying before dryer 420. The transport device 430, knowing this can be issued a control signal to wait near the dryer 421 that is scheduled to finish first so that the transport device 430 can take the bin, transport it near one of the hoppers 410.1 and/or 410.2, deposit the produce into the hopper and then set the empty bin down to be returned. The transport device 430 can then go back and pick up the bin that is waiting at the pickup station 440 and transport it to the dryer 421. After it completes that movement, the dryer 420 may have completed its drying cycle so the transport device will then move that bin and produce to a selected hopper as well.

In this way, the system 400 can schedule a series of movements of the transport device 430 based on the current status of each element in the system 400. The status of each element can be determined through collected sensor data and/or locally created and transmitted information indicating the status of each element. Accordingly, the transport device 430 can be an automated guided vehicle (AGV).

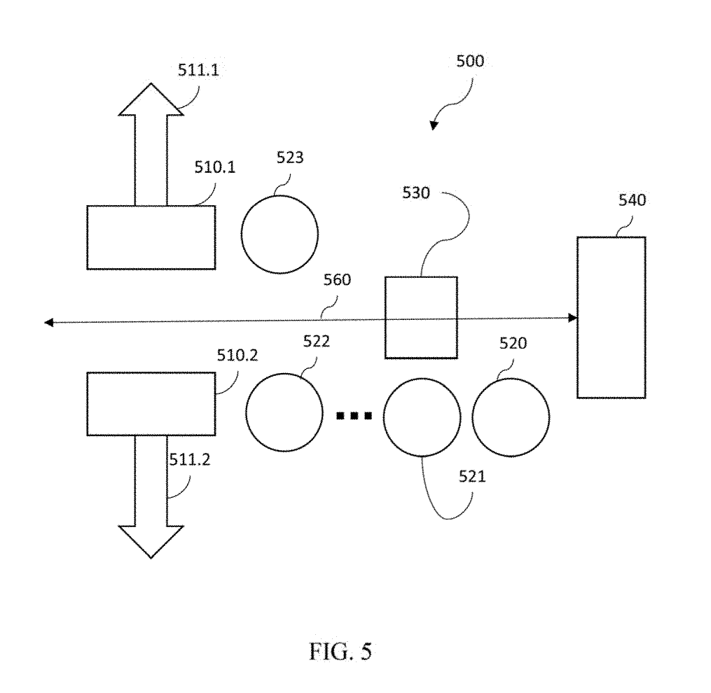

FIG. 5 illustrates a schematic diagram of a produce wash system 500 with a plurality of dryers 520, 521, 522, and 523 in accordance with one or more embodiments. The system 500 also includes a pickup station 540, a transport device 530, and one or more hoppers 510.1 and 510.2 with corresponding conveyers 511.1 and 511.2. Similar to FIG. 4, the system can utilize a number of dryers running concurrently and do so by loading and unloading the dryers using the transport device 530.

For example, initially the pickup station 540 can include a plurality of bins such that the number of bins meets or exceeds the number of total dryers in the system 500. Accordingly, the transport device 530 can be provided with command instructions to load each of the dryers with a bin for drying. A loading pattern selected can be determined based on efficiency, user input, a preselected load pattern, and/or other information. The loading pattern includes a series of command instructions that indicate to the transport device which bins to select and what dryer to use for each bin and in what order. For example, the transport device 530 initially queue up a series of loading steps to select bins from the pickup station 540 and load the dryers starting with the closest dryer 520 to the pickup station 540 first and then move on the next closest empty dryer 521, then 522, then 523. Alternatively, the transport device 530 can load the furthest first and the nearest last. Further, any other assortment of selective loading can take place. For example, the transport device 530 can be instructed to load the slowest dryers first which can be in part due to the dryer, the type of produce in the bin, the size of the bin, the specific load in the bin, the weight of the bin, other information, and/or a combination thereof. The transport device 530 loads each dryer by moving along the predetermined path 560.

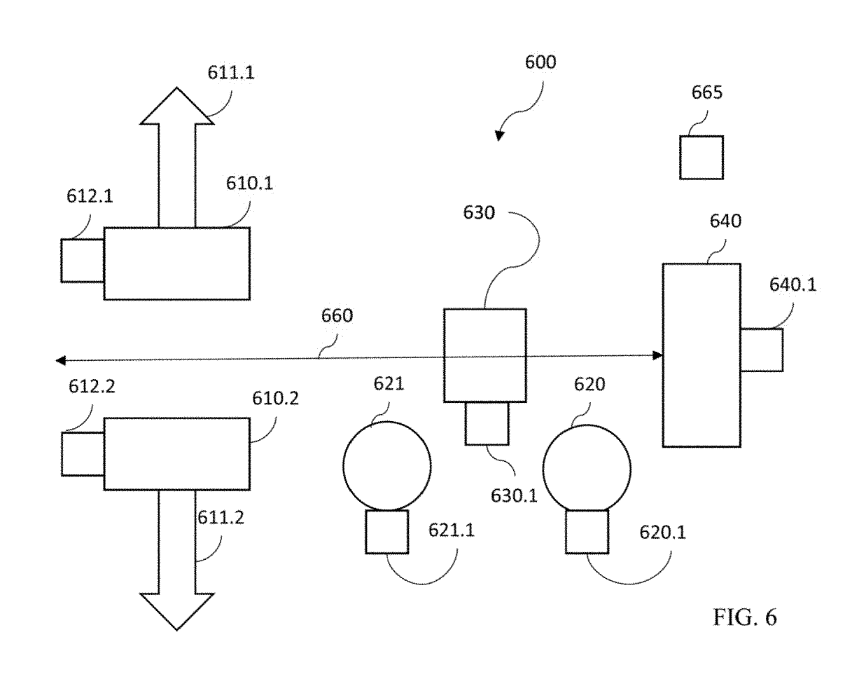

FIG. 6 illustrates a schematic diagram of a produce wash system 600 with one or more sensors in accordance with one or more embodiments. As shown the produce wash system 600 includes a pickup station 640 that includes a sensor 640.1. The sensor 640.1 can be a camera sensor or weight sensor that helps determine the specific bin location and load. The system 600 also includes a transport device 630 that includes a sensor 630.1 and moves along a vehicle path 660. The sensor 630.1 can be an internal sensor that collects transport device 630 information relating to the transport device 630 components or the sensor 630.1 can be a sensor that determines the transport device 630 location or the location of elements in and around the transport device 630. Further, the system 600 includes a first dryer 620 that includes a sensor 620.1 and a second dryer 621 that includes a sensor 621.1. The sensors 620.1 and 621.1 can be detectors that determine the weight, water content, temperature, rotation speed, and other information about the dryer that can be used to determine information about the drying of the product in the dryer. The system 600 also includes one or more hoppers 610.1 and 610.2 that can include sensors 612.1 and 612.2 that can help determine the current capacity usage of each hopper as product is being deposited into the hoppers 610.1 and 610.2.

Further, although only one sensor is shown with each system element in other embodiments a plurality of sensors can be included with one or more of the system components. Further, in other embodiments, one or more of the components may not include a sensor. Further, as shown, a sensor 665 can be included that is independent of any of the components and can be used to provide tracking information of one or more of the moving components of the system or that are moving within the system. According to one or more cases, for example, a camera sensor 665 can be provided that can track the location of all the bins in the system as well as the current location of the transport device 630. Further the camera sensor 665 can track any foreign objects that move within the system 600 such as workers or other objects that may or may not be allowed.

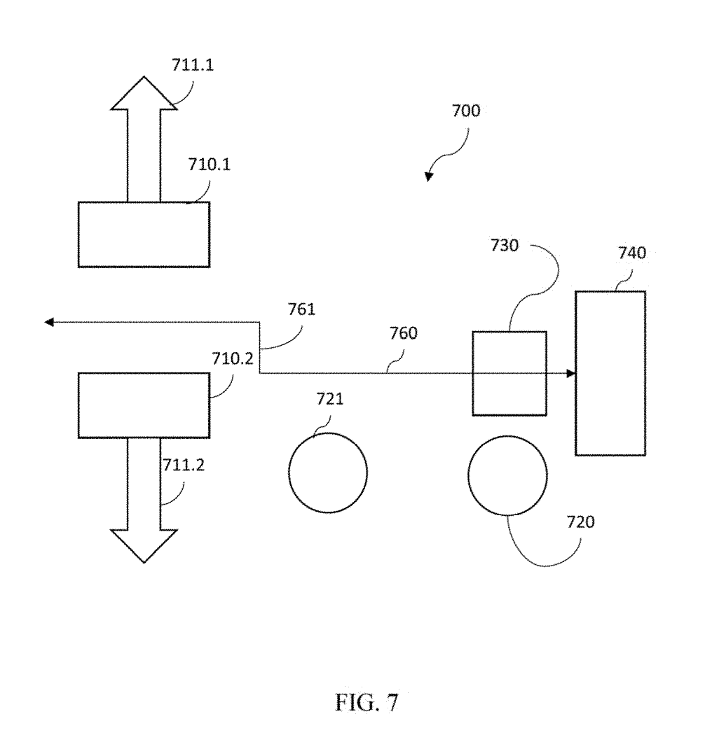

FIG. 7 illustrates a schematic diagram of a produce wash system 700 with a variable vehicle path 760 in accordance with one or more embodiments. The system 700 includes a pickup station 740, a plurality of dryers 720 and 721, and a plurality of hoppers/conveyers 711.1, 711.2, 710.1, and 710.2, and a transport device 730 that is able to move between each of the other system 700 components. In this case, as shown, the hoppers/conveyers 711.1, 711.2, 710.1, and 710.2 have moved such that they are now offset from the rest of the system 700. Accordingly, the path 760 of the transport device 730 is adjusted such that the transport device 730 can turn and move along an adjusted path portion 761 and maneuver so that it can still move between all the elements in order to deliver the product from the pickup station 740, to the dryers 720 and 721, and then to the hoppers/conveyers 711.1, 711.2, 710.1, and 710.2.

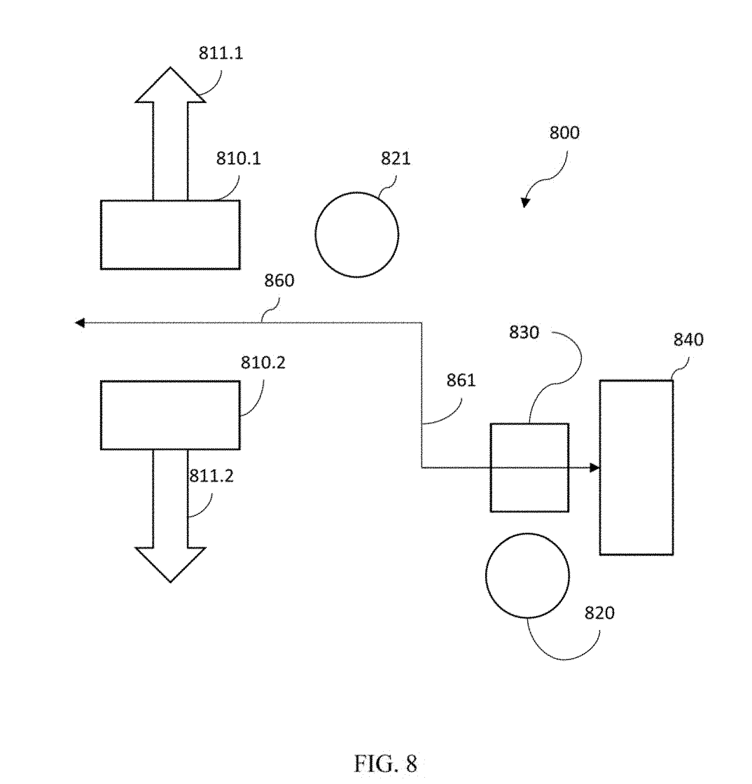

FIG. 8 illustrates a schematic diagram of a produce wash system 800 with another variable vehicle path 860 in accordance with one or more embodiments. The variable vehicle path includes an adjusted path portion 861. As shown, the system 800 includes a pickup station 840, a transport device 830, a plurality of dryers 820 and 821, and a plurality of hoppers/conveyers 811.1, 811.2, 810.1, and 810.2. In this case, as shown, the system is arranged such that part of the system that includes the pickup station 840 and at least one dryer 820 is offset from the rest of the system 800. This arrangement is for exemplary purposes and other variable arrangements can also be provided for the system 800. As shown, the transport device 830 is able to adjust the path 860 to include a portion 861 which provides a routing along which the transport device 830 can move the bins and produce through the system 800.

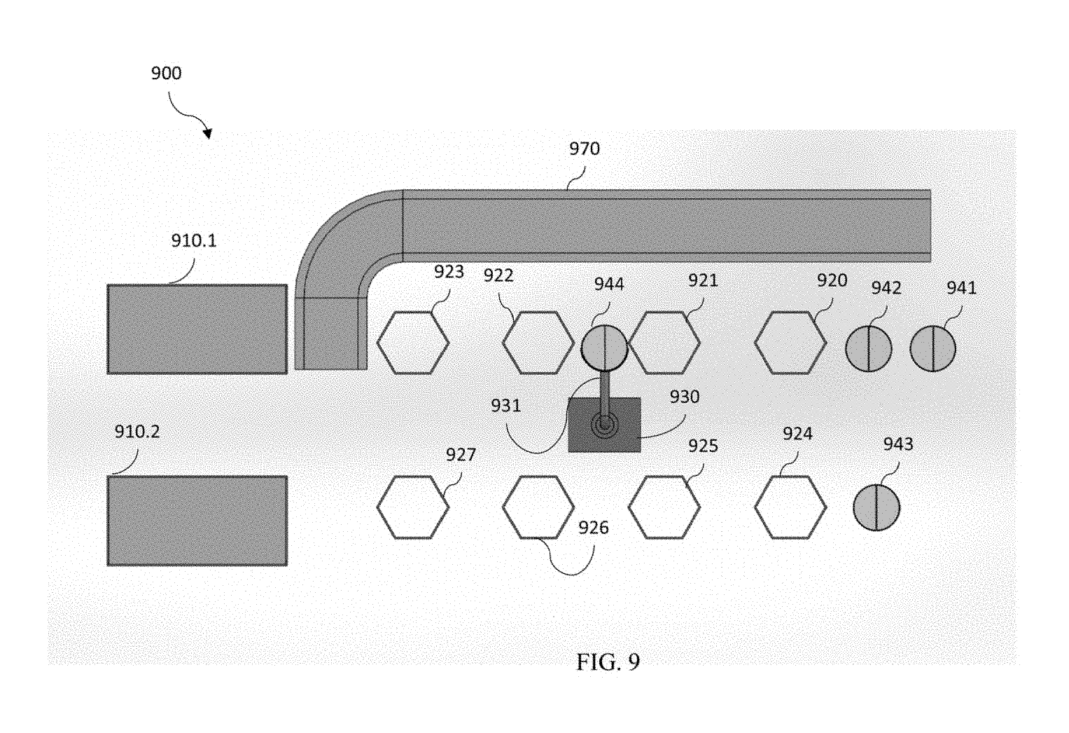

FIG. 9 illustrates a top view of a produce dryer system 900 including a plurality of features in accordance with one or more embodiments. As shown, the system 900 includes a first hopper 910.1 and as second hopper 910.2. The system 900 also includes a transport device 930. The transport device 930 may also be called a shuttle. The transport device 930 includes an arm 931 that is configured to grab a dryer bin 944 from a group of dryer bins 941, 942, 943, and 944 that are initialed placed in an area that is designated as a pickup station that can also be called a pickup area or zone. The system 900 also includes a return conveyer 970 for empty dryer bins. The system 900 further includes a plurality of dryers 920-927 that are arranged in two rows (a first row includes dryers 920, 921, 922, and 923 and a second row includes dryers 924, 925, 926, and 927) on either side of the transport device 930. As shown, the transport device 930 has open space that traverses the length of the system 900 within which the transport device 930 can travel to reach each of the other elements of the system 900.

As shown, the transport device 930 is in a position between dryers 921 and 922 holding the dryer bin 944. This positioning shows how the arm 931 of the transport device 930 is able to hold a dryer bin such that is can lift and lower the bin in and/or out of any of the dryers 920-927. The arm 931 can also rotate while holding the dryer bin 944 such that the dryer bin 944 can be placed or removed from one of the second row of dryers 924, 925, 926, and 927.

Further, once the bin is dried by one of the dryers, the transport device 930 can grab the bin and move it over one of the hoppers 910.1 and 910.2. The arm 931 can then rotate the bin depositing the contents of the bin into one of the hoppers 910.1 and 910.2. In another case, the bin 944 can receive a signal from the arm 931, transport device 930, or from another element of the system 900 that triggers the bin 944 to open and drop the contents within into one of the hoppers 910.1 and 910.2. In another case, the arm physically actuates a switch on the bin that causes the bin to open and release the contents.

Once the bin 944 is empty, the transport device 930 moves into a position adjacent to the return conveyer 970 and then rotates the arm 931 such that the bin 944 is above the return conveyer 970. The arm 931 can then lower and deposit the bin 944 onto the return conveyer 970. The return conveyer 970 can return the bin 944 to another location in the processing plant where it can be taken and filled again with wet produce and set within the pickup station. At this point, the system 900 can control the transport device 930 to queue up the newly filled bin for pickup up and drying.

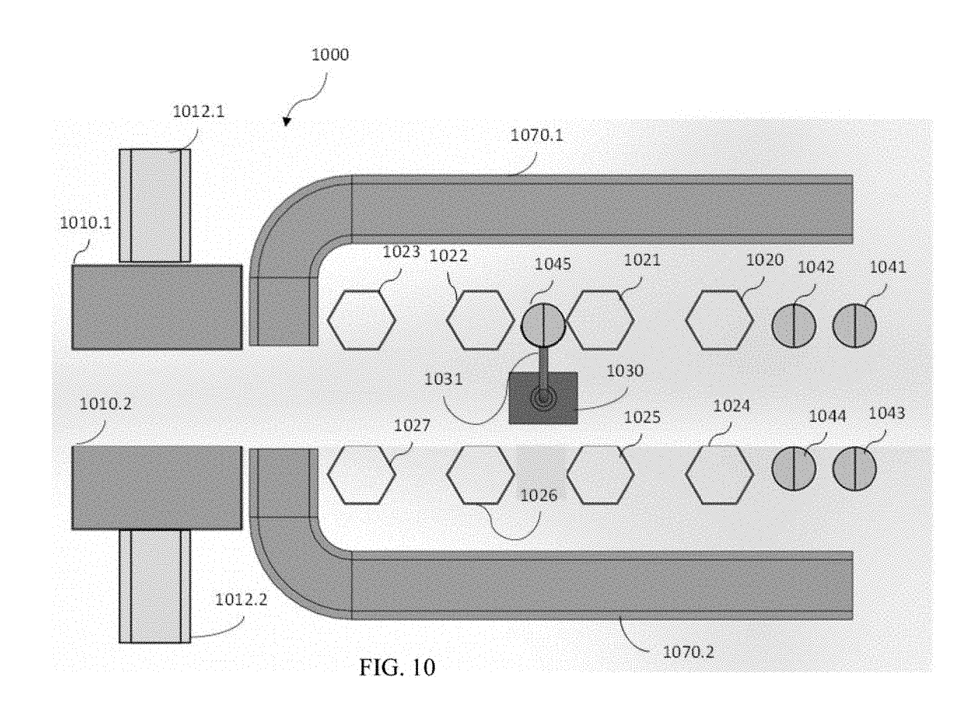

FIG. 10 illustrates a top view of a produce dryer system 1000 including additional conveyers and other features in accordance with one or more embodiments. As shown, the produce dryer system 1000 includes a plurality of dryer bins 1041, 1042, 1043, 1044, and 1045. In other embodiments, the system can include a different number of bins. The system 1000 further includes a plurality of dryers 1020, 1021, 1022, 1023 in a first row. The system 1000 also includes a plurality of dryers 1023, 1025, 1026, and 1027 in a second row. The system 1000 also includes a first hopper 1010.1 and a second hopper 1010.2. The first hopper 1010.1 and the second hopper 1010.2 each have a first conveyer 1012.1 and a second conveyer 1012.2 connected to the first hopper 1010.1 and the second hopper 1010.2, respectively. The first conveyer 1012.1 and the second conveyer 1012.2 are positioned to receive produce that has been deposited in respective hopper 1010.1 or 1010.2 from one or more bins 1041-1045 that have been run through one of the dryers 1020-1027. The produce is transported by the first and second conveyers 1012.1 and 1012.2 to other systems in the produce processing plant for further handling. For example, the produce could be transported to a packaging system. Further, the system includes a first return conveyer 1070.1 and a second return conveyer 1070.2. As shown the return conveyers 1070.1 and 1070.2 are positioned on either side of the system in a mirrored fashion.

In other embodiments, the conveyers can be placed in other arrangements as determined by the layout of the processing plant and other systems. For example, as shown both conveyers return bins generally back in the direction they were originally picked up from. In other cases, one of the conveyers could transport bins to other locations in the processing plant. Further, in another case, each conveyer could return bin to different produce processing portions of the plant that are processing different product. In another case, the bins themselves can be of at least two different types and the different conveyers can be used to return a specific type of bin to a specific location in the processing plant. Further, according to another case, the drop off point of the conveyers 1070.1 and 1070.2 can be placed elsewhere along the system 1000.

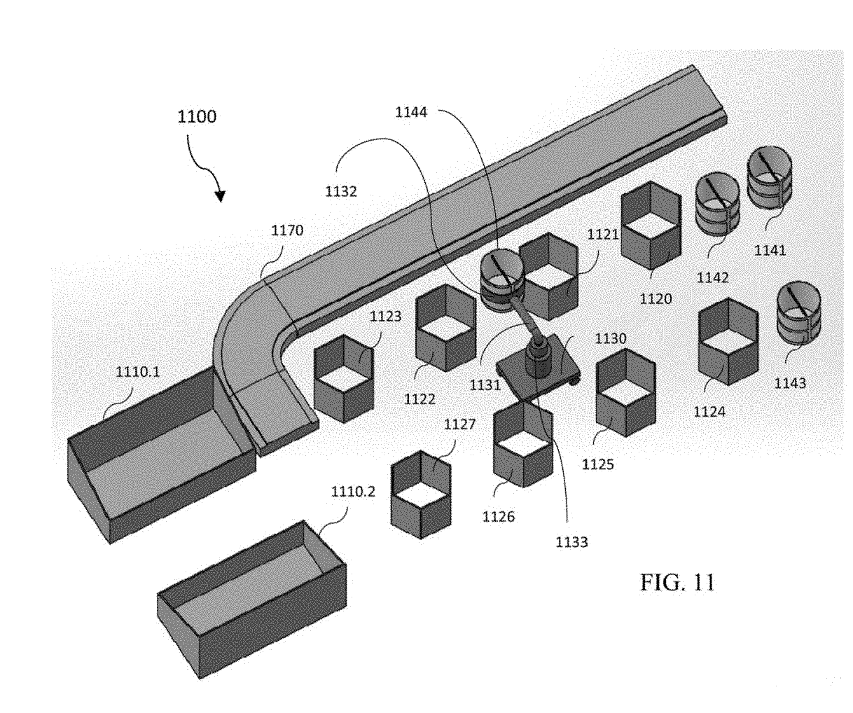

FIG. 11 illustrates a top perspective view of a produce dryer system 1100 including a plurality of features in accordance with one or more embodiments. As shown, the system 1100 includes a first hopper 1110.1 and a second hopper 1110.2. The system 1100 also includes a transport device 1130. The transport device 1130 includes an arm 1131 that is configured to grab a dryer bin 1144 from a group of dryer bins 1141, 1142, 1143, and 1144 that are initially placed in an area that is designated as a pickup station that can also be called a pickup area or zone. The system 1100 also includes a return conveyer 1170 for empty dryer bins. The system 1100 further includes a plurality of dryers 1120-1127 that are arranged in two rows (a first row includes dryers 1120, 1121, 1122, and 1123 and a second row includes dryers 1124, 1125, 1126, and 1127) on either side of the transport device 1130. As shown, the transport device 1130 has open space that traverses the length of the system 1100 within which the transport device 1130 can travel to reach each of the other elements of the system 1100.

As shown, the transport device 1130 is in a position between dryers 1121 and 1122 holding the dryer bin 1144. This positioning shows how the arm 1131 of the transport device 1130 is able to hold the dryer bin 1144 such that is can lift and lower the bin 1144 in and/or out of any of the dryers 1120-1127. The arm 1131 can also rotate while holding the dryer bin 1144 such that the dryer bin 1144 can be placed or removed from one of the second row of dryers 1124, 1125, 1126, and 1127.

Further, once the bin 1144 is dried by one of the dryers, 1120-1127 the transport device 1130 can grab the bin 1144 and move it over one of the hoppers 1110.1 and 1110.2. The arm 1131 can then rotate the bin 1144 depositing the contents of the bin 1144 into one of the hoppers 1110.1 and 1110.2. In another case, the bin 1144 can receive a signal from the arm 1131, transport device 1130, or from another element of the system 1100 that triggers the bin 1144 to open and drop the contents within into one of the hoppers 1110.1 and 1110.2. In another case, the arm 1131 physically actuates a switch on the bin 1144 that causes the bin 1144 to open and release the contents.

Once the bin 1144 is empty, the transport device 1130 moves into a position adjacent to the return conveyer 1170 and then rotates the arm 1131 such that the bin 1144 is above the return conveyer 1170. The arm 1131 can then lower and deposit the bin 1144 onto the return conveyer 1170. The return conveyer 1170 can return the bin 1144 to another location in the processing plant where it can be taken and filled again with wet produce and set within the pickup station. At this point, the system 1100 can control the transport device 1130 to queue up the newly filled bin for pickup up and drying.

Further, as shown in FIG. 11, the system 1100 also includes a clamp 1132 attached at one end of the arm 1131 of the transport device 1130. The other end of the arm 1131 is shown to connect to a chassis of the transport device 1130 using a driven lift 1133 that is arranged such that it can lift and lower the arm 1131 and clamp 1132. Although one form of a clamp and driven lift are depicted in FIG. 11, other clap types and lift mechanics can be used in accordance with other embodiments.

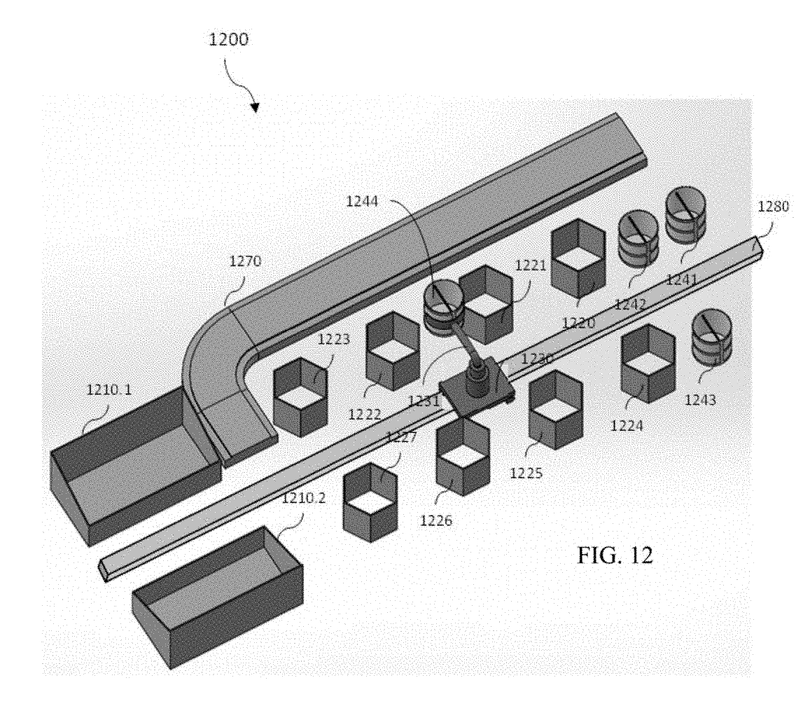

FIG. 12 illustrates a top perspective view of a produce dryer system 1200 including a vehicle track 1280 in accordance with one or more embodiments.

As shown, the system 1200 includes a first hopper 1210.1 and as second hopper 1210.2. The system 1200 also includes a transport device 1230. The transport device 1230 includes an arm 1231 that is configured to grab a dryer bin 1244 from a group of dryer bins 1241, 1242, 1243, and 1244 that are initially placed in an area that is designated as a pickup station that can also be called a pickup area or zone. The system 1200 also includes a return conveyer 1270 for empty dryer bins. The system 1200 further includes a plurality of dryers 1220-1227 that are arranged in two rows (a first row includes dryers 1220, 1221, 1222, and 1223 and a second row includes dryers 1224, 1225, 1226, and 1227) on either side of the transport device 1230. As shown, the transport device 1230 has open space that traverses the length of the system 1200 within which the transport device 1230 can travel to reach each of the other elements of the system 1200.

Further, in accordance with one or more embodiments, the vehicle track 1280 extends from one end to the other of this open space along which the transport device 1230 moves. As shown the vehicle track 1280 is formed of a long and raised portion that extends along the travel path that the transport device 1230 moves along. This long and raised portion that extends up from the floor surface provides guiding sides that the transport device 1230 can come in contact with and move along to help the transport device 1230 stay on the travel path.

As shown, the transport device 1230 is in a position between dryers 1221 and 1222 holding the dryer bin 1244. This positioning shows how the arm 1231 of the transport device 1230 is able to hold the dryer bin 1244 such that it can lift and lower the bin 1244 in and/or out of any of the dryers 1220-1227. The arm 1231 can also rotate while holding the dryer bin 1244 such that the dryer bin 1244 can be placed or removed from one of the second row of dryers 1224, 1225, 1226, and 1227.

Further, once the bin 1244 is dried by one of the dryers, 1220-1227 the transport device 1230 can grab the bin 1244 and move it over one of the hoppers 1210.1 and 1210.2. The arm 1231 can then rotate the bin 1244 depositing the contents of the bin 1244 into one of the hoppers 1210.1 and 1210.2. In another case, the bin 1244 can receive a signal from the arm 1231, transport device 1230, or from another element of the system 1200 that triggers the bin 1244 to open and drop the contents within into one of the hoppers 1210.1 and 1210.2. In another case, the arm 1231 physically actuates a switch on the bin 1244 that causes the bin 1244 to open and release the contents.

Once the bin 1244 is empty, the transport device 1230 moves into a position adjacent to the return conveyer 1270 and then rotates the arm 1231 such that the bin 1244 is above the return conveyer 1270. The arm 1231 can then lower and deposit the bin 1244 onto the return conveyer 1270. The return conveyer 1270 can return the bin 1244 to another location in the processing plant where it can be taken and filled again with wet produce and set within the pickup station. At this point, the system 1200 can control the transport device 1230 to queue up the newly filled bin for pickup up and drying.

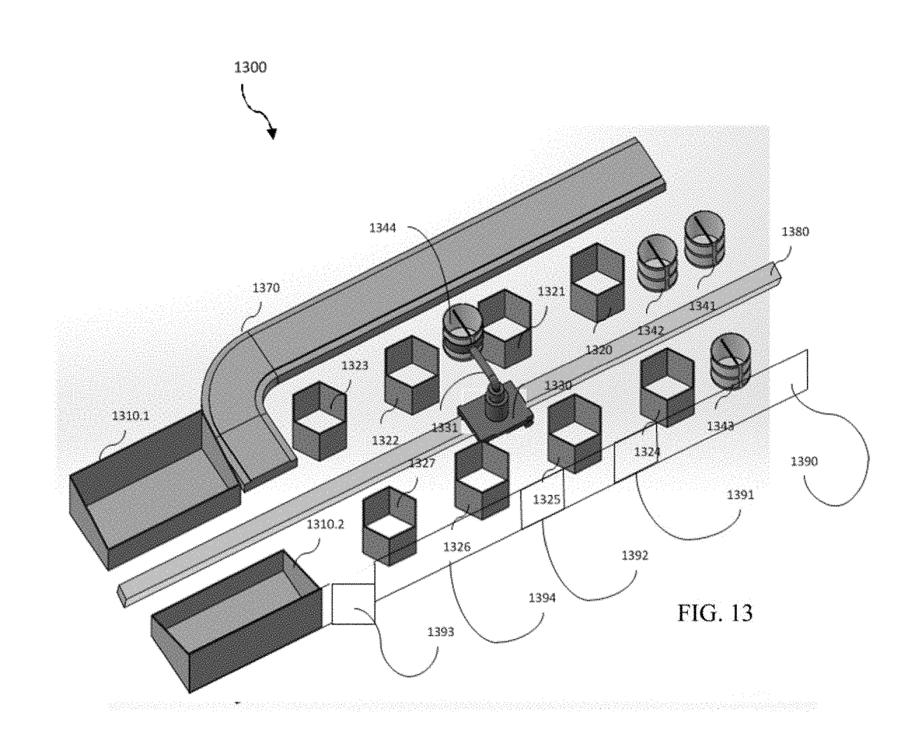

FIG. 13 illustrates a top perspective view of a produce dryer system 1300 including a gated interlock system 1390 in accordance with one or more embodiments.

As shown, the system 1300 includes a first hopper 1310.1 and as second hopper 1310.2. The system 1300 also includes a transport device 1330. The transport device 1330 includes an arm 1331 that is configured to grab a dryer bin 1344 from a group of dryer bins 1341, 1342, 1343, and 1344 that are initially placed in an area that is designated as a pickup station that can also be called a pickup area or zone. The system 1300 also includes a return conveyer 1370 for empty dryer bins. The system 1300 further includes a plurality of dryers 1320-1327 that are arranged in two rows (a first row includes dryers 1320, 1321, 1322, and 1323 and a second row includes dryers 1324, 1325, 1326, and 1327) on either side of the transport device 1330. As shown, the transport device 1330 has open space that traverses the length of the system 1300 within which the transport device 1330 can travel to reach each of the other elements of the system 1300.

Further, in accordance with one or more embodiments, the vehicle track 1380 extends from one end to the other of this open space along which the transport device 1330 moves. As shown the vehicle track 1380 is formed of a long and raised portion that extends along the travel path that the transport device 1330 moves along. This long and raised portion that extends up from the floor surface provides guiding sides that the transport device 1330 can come in contact with and move along to help the transport device 1330 stay on the travel path.

As shown, the transport device 1330 is in a position between dryers 1321 and 1322 holding the dryer bin 1344. This positioning shows how the arm 1331 of the transport device 1330 is able to hold the dryer bin 1344 such that is can lift and lower the bin 1344 in and/or out of any of the dryers 1320-1327. The arm 1331 can also rotate while holding the dryer bin 1344 such that the dryer bin 1344 can be placed or removed from one of the second row of dryers 1324, 1325, 1326, and 1327.

Further, once the bin 1344 is dried by one of the dryers, 1320-1327 the transport device 1330 can grab the bin 1344 and move it over one of the hoppers 1310.1 and 1310.2. The arm 1331 can then rotate the bin 1344 depositing the contents of the bin 1344 into one of the hoppers 1310.1 and 1310.2. In another case, the bin 1344 can receive a signal from the arm 1331, transport device 1330, or from another element of the system 1300 that triggers the bin 1344 to open and drop the contents within into one of the hoppers 1310.1 and 1310.2. In another case, the arm 1331 physically actuates a switch on the bin 1344 that causes the bin 1344 to open and release the contents.

Once the bin 1344 is empty, the transport device 1330 moves into a position adjacent to the return conveyer 1370 and then rotates the arm 1331 such that the bin 1344 is above the return conveyer 1370. The arm 1331 can then lower and deposit the bin 1344 onto the return conveyer 1370. The return conveyer 1370 can return the bin 1344 to another location in the processing plant where it can be taken and filled again with wet produce and set within the pickup station. At this point, the system 1300 can control the transport device 1330 to queue up the newly filled bin for pickup up and drying.

Further, as shown in FIG. 13, the system 1300 also includes the gated interlock system 1390. The gated interlock system 1390 includes a barrier 1394 that extends along at least one side of the system 1300 as shown. This barrier 1394 denies access to the area and system to any plant employees and/or other plant devices including but not limited to other transport devices. According to other embodiments, the barrier 1394 can extend along other sides of the system 1300. Further, in another case, the barrier 1394 can extend along the entire perimeter of the system 1300. The gated interlock system 1390 further includes one or more gates 1391, 1392, and 1393 that remain shut unless a certain set of conditions are met that allow the one or more gates 1391, 1392, and 1393 to unlock and/or swing open. As shown, gates 1391 and 1392 are positioned on either side of dryer 1325 in the space between dryers. Accordingly, when these gates are open access is provided between the dryers. Further, gate 1393 is positioned between dryer 1327 and hopper 1310.2 providing entry into the system at that particular entry and exit point. According to other embodiments, the gates can be positioned anywhere along the barrier 1394. Also, according to other embodiments, the gates can all very in shape and dimensions. According to another case, the gates can slide open rather than swing open as shown. According to another case, the gates and lower into the ground, roll up, and/or accordion together.

According to one or more embodiments, the gates can open and close according to one or more different conditions. For example, the gate conditions for opening can be set to be one or more of the following. In one case, the gates can remain closed and locked when the transport device 1330 is a certain distance from the gates. In another case, the speed and direction of the transport device can be used to determine when gates are opened or closed. Further, if dryers are actively drying can be a factor used to determine which and when gates are open and closed. According to other embodiments, the time of day, the operation cycle, sensor collected values, and/or user input can be used to help determine which gates are opened and which remain closed.

Also, a combination of one or more of the above factors can be used together to determine what gates to open and close. For example, according to one case, gate 1392 is closed because of the proximity of the transport device 1330. Gate 1391 is closed because of the programed direction the transport device 1330 is being controlled to move. Further, gate 1393 is shown as being open because that gate 1393 received an earlier request from a user to open and is now a safe distance away from the moving transport device 1330 and any operating dryers as well as the known future position of the transport device 1330.

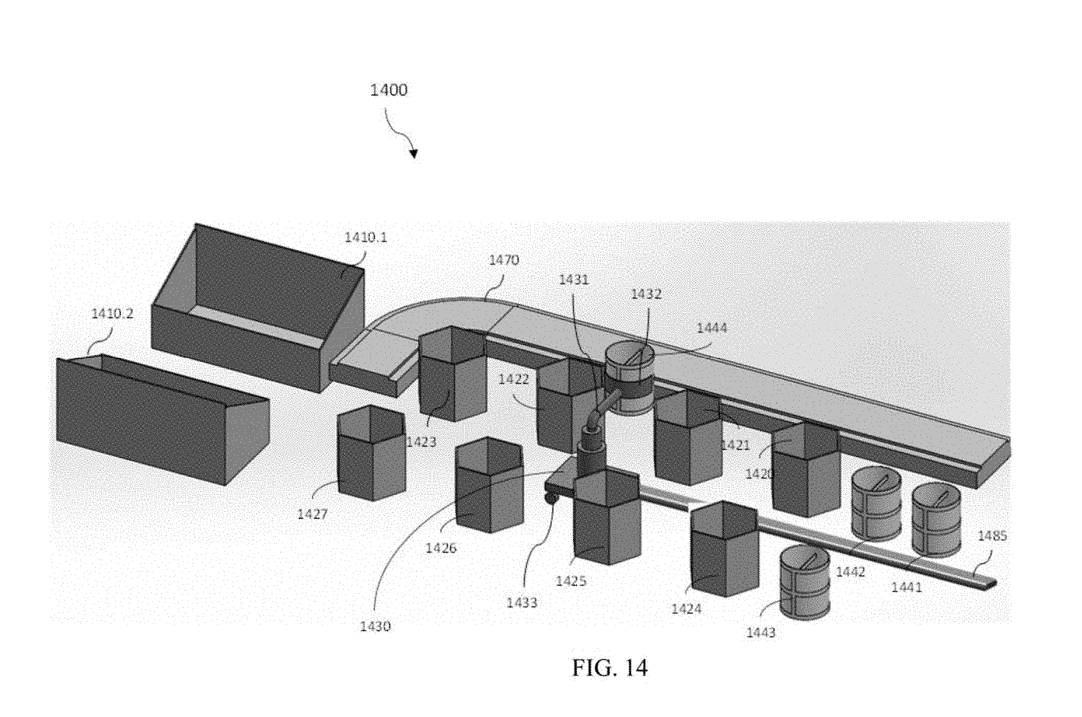

FIG. 14 illustrates a side perspective view of a produce dryer system 1400 including power cabling 1485 in accordance with one or more embodiments. As shown, the system 1400 includes a first hopper 1410.1 and as second hopper 1410.2. The system 1400 also includes a transport device 1430. The transport device 1430 includes an arm 1431 that is configured to grab a dryer bin 1444 from a group of dryer bins 1441, 1442, 1443, and 1444 that are initially placed in an area that is designated as a pickup station that can also be called a pickup area or zone. The system 1400 also includes a return conveyer 1470 for empty dryer bins. The system 1400 further includes a plurality of dryers 1420-1427 that are arranged in two rows (a first row includes dryers 1420, 1421, 1422, and 1423 and a second row includes dryers 1424, 1425, 1426, and 1427) on either side of the transport device 1430. As shown, the transport device 1430 has open space that traverses the length of the system 1400 within which the transport device 1430 can travel to reach each of the other elements of the system 1400.

As shown, the transport device 1430 is in a position between dryers 1421 and 1422 holding the dryer bin 1444. This positioning shows how the arm 1431 of the transport device 1430 is able to hold the dryer bin 1444 such that is can lift and lower the bin 1444 in and/or out of any of the dryers 1420-1427. The arm 1431 can also rotate while holding the dryer bin 1444 such that the dryer bin 1444 can be placed or removed from one of the second row of dryers 1424, 1425, 1426, and 1427.

Further, once the bin 1444 is dried by one of the dryers, 1420-1427 the transport device 1430 can grab the bin 1444 and move it over one of the hoppers 1410.1 and 1410.2. The arm 1431 can then rotate the bin 1444 depositing the contents of the bin 1444 into one of the hoppers 1410.1 and 1410.2. In another case, the bin 1444 can receive a signal from the arm 1431, transport device 1430, or from another element of the system 1400 that triggers the bin 1444 to open and drop the contents within into one of the hoppers 1410.1 and 1410.2. In another case, the arm 1431 physically actuates a switch on the bin 1444 that causes the bin 1444 to open and release the contents.

Once the bin 1444 is empty, the transport device 1430 moves into a position adjacent to the return conveyer 1470 and then rotates the arm 1431 such that the bin 1444 is above the return conveyer 1470. The arm 1431 can then lower and deposit the bin 1444 onto the return conveyer 1470. The return conveyer 1470 can return the bin 1444 to another location in the processing plant where it can be taken and filled again with wet produce and set within the pickup station. At this point, the system 1400 can control the transport device 1430 to queue up the newly filled bin for pickup up and drying.

Further, as shown in FIG. 14, the system 1400 also includes the power cabling 1485. The power cabling 1485 is connected at one end to the transport device 1433. The other end of the power cabling 1485 is connected to at least a power source that provides power to the transport device 1433. The power cabling 1485, in another case, can also be connected to a communication and control device and can transmit data and control signals to and from the transport device. According to one or more embodiments, the power cabling 1485 can be a chain style cabling that bends back onto itself and then extends out as the transport device 1433 moves along the transport path. The power cabling 1485 can also be a number of other types of cabling as known that can be connected to the moving transport device 1433 to a power and/or communication source.

Alternatively, in accordance with another case, a transport device can be powered by on onboard battery mounted on or in the transport device chassis. Accordingly, the transport device could operate and move free of any cabling. Further, the transport device could also include wireless communication capabilities for sending and receiving sensor data and control signals. In this case, the transport device would operate until it detected that its power source was running low and would then leave the system and travel to a charging docking station and a second transport device would take its place.

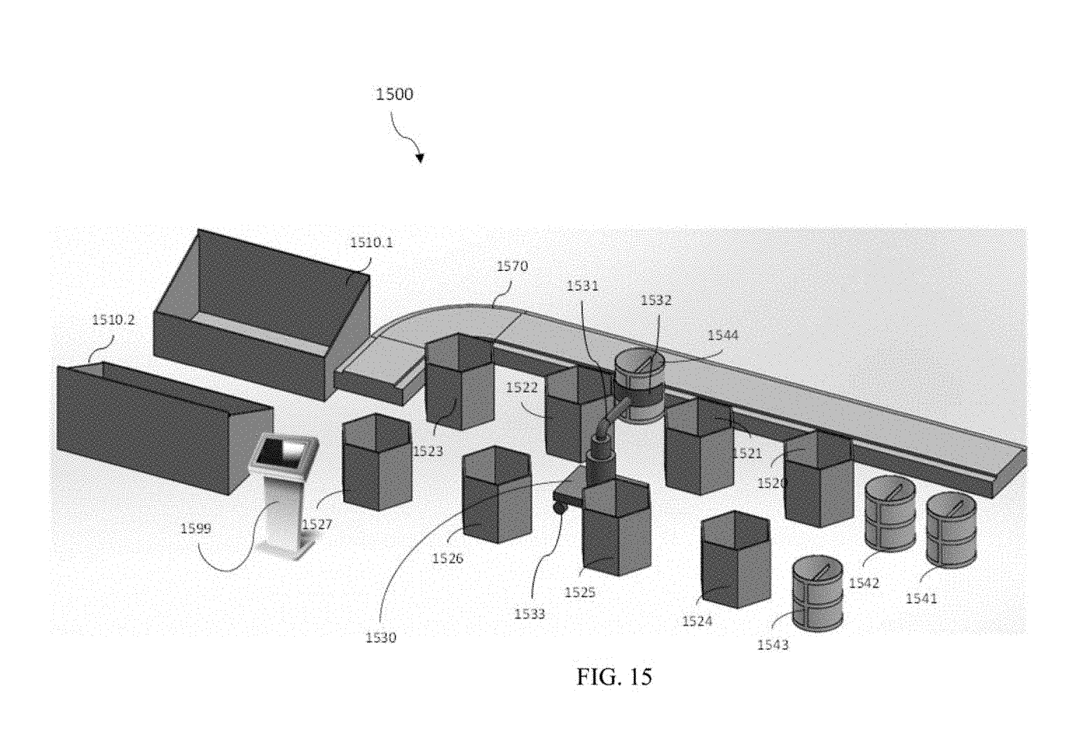

FIG. 15 illustrates a side perspective view of a produce dryer system 1500 including a programmable logic controller (PLC) that includes a human machine interface (HMI) 1599 in accordance with one or more embodiments. As shown, the system 1500 includes a first hopper 1510.1 and as second hopper 1510.2. The system 1500 also includes a transport device 1530. The transport device 1530 includes an arm 1531 that is configured to grab a dryer bin 1544 from a group of dryer bins 1541, 1542, 1543, and 1544 that are initialed placed in an area that is designated as a pickup station that can also be called a pickup area or zone. The system 1500 also includes a return conveyer 1570 for empty dryer bins. The system 1500 further includes a plurality of dryers 1520-1527 that are arranged in two rows (a first row includes dryers 1520, 1521, 1522, and 1523 and a second row includes dryers 1524, 1525, 1526, and 1527) on either side of the transport device 1530. As shown, the transport device 1530 has open space that traverses the length of the system 1500 within which the transport device 1530 can travel to reach each of the other elements of the system 1500.

As shown, the transport device 1530 is in a position between dryers 1521 and 1522 holding the dryer bin 1544. This positioning shows how the arm 1531 of the transport device 1530 is able to hold the dryer bin 1544 such that is can lift and lower the bin 1544 in and/or out of any of the dryers 1520-1527. The arm 1531 can also rotate while holding the dryer bin 1544 such that the dryer bin 1544 can be placed or removed from one of the second row of dryers 1524, 1525, 1526, and 1527.

Further, once the bin 1544 is dried by one of the dryers, 1520-1527 the transport device 1530 can grab the bin 1544 and move it over one of the hoppers 1510.1 and 1510.2. The arm 1531 can then rotate the bin 1544 depositing the contents of the bin 1544 into one of the hoppers 1510.1 and 1510.2. In another case, the bin 1544 can receive a signal from the arm 1531, transport device 1530, or from another element of the system 1500 that triggers the bin 1544 to open and drop the contents within into one of the hoppers 1510.1 and 1510.2. In another case, the arm 1531 physically actuates a switch on the bin 1544 that causes the bin 1544 to open and release the contents.

Once the bin 1544 is empty, the transport device 1530 moves into a position adjacent to the return conveyer 1570 and then rotates the arm 1531 such that the bin 1544 is above the return conveyer 1570. The arm 1531 can then lower and deposit the bin 1544 onto the return conveyer 1570. The return conveyer 1570 can return the bin 1544 to another location in the processing plant where it can be taken and filled again with wet produce and set within the pickup station. At this point, the system 1500 can control the transport device 1530 to queue up the newly filled bin for pickup up and drying.

Further, as shown in FIG. 15, the system 1500 also includes the programmable logic controller (PLC) that includes a human machine interface (HMI) 1599. As shown the PLC HMI 1599 is shown as a kiosk 1599. According to another case, the kiosk can only include the HMI while the PLC is located elsewhere such as in a server room or in a distributed network, or elsewhere. As shown the kiosk 1599 is placed at a position near the overall system 1500 with a clear vantage point of most if not all of the resources and elements in the system 1500. According to one or more embodiments, the kiosk 1599 can be used by a user such as a plant employee to enter controlling information that is used to operate the system 1500. For example, specific programming for which dryers to use for what produce can be entered. Also, selection of what dryer to use for each bin in the pickup area can be programmed. Alternatively, in another case, general control parameters can be entered. For example, a general control parameter includes instructions such as telling the system to operate in a manner that is least taxing to the transport device 1533. In another case, the user can enter general control parameters telling the system to equally split the load among the dryers or it can assign heavier load usage to newer or better dryers. Also, a user can tell the system that a certain dryer will be taken offline and request that it not be used and that gates be opened so the user can enter and access the dryer. Further, the user that enters other parameters such as the speed the transport device can operate. According to other embodiments, other inputs can be provided by a user.

Further, the kiosk 1599 can also provide information to a user about the system. For example, the kiosk can display all the sensor information that has been and is actively being collected by the system 1500. Further, the kiosk 1599 can show the user the queue of which bins are going to be taken to what dryer and in what order. Other information can also be provided to a user such as a system usage, throughput, and dry quality as well as other information.

In other embodiments, the HMI can be implemented on a mobile device such as a smartphone or tablet. In other embodiments, the HMI can be accessed using a computer that logins into a portal page that provides access to the system as described above. Further, according to one or more embodiments, the specific device and/or user can be identified and the specific control and information provided can be specifically selected for that user and/or device.

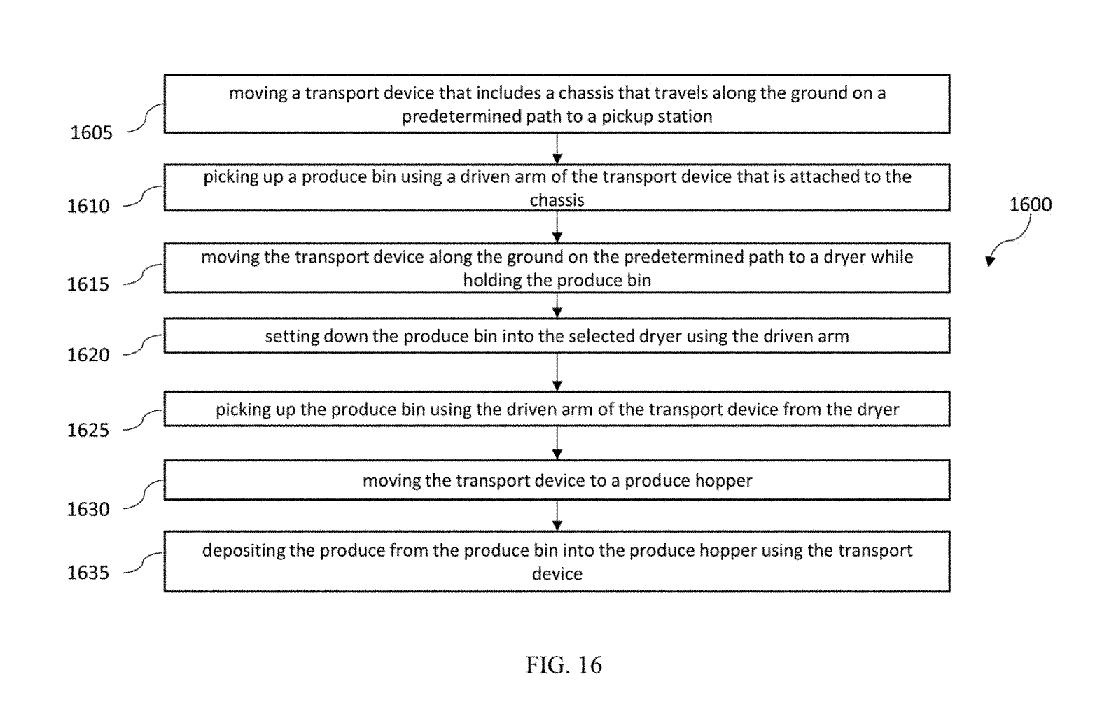

FIG. 16 illustrates a flow chart of a method 1600 of operating a produce dryer system in accordance with one or more embodiments. The method 1600 includes moving a transport device that includes a chassis that travels along the ground on a predetermined path to a pickup station (operation 1605). The method 1600 also includes picking up a produce bin using a driven arm of the transport device that is attached to the chassis (operation 1610). Further, the method 1600 includes moving the transport device along the ground on the predetermined path to a dryer while holding the produce bin (operation 1615). The method 1600 also includes setting down the produce bin into the selected dryer using the driven arm (operation 1620) and picking up the produce bin using the driven arm of the transport device from the dryer (operation 1625). The method 1600 additionally includes moving the transport device to a produce hopper (operation 1630) and depositing the produce from the produce bin into the produce hopper using the transport device (operation 1635).

According to another case, the method 1600 can further include receiving the produce bin at the pickup station. According to another case, the method 1600 can further include selecting the dryer from a plurality of dryers based on collected system information. According to another case, the method 1600 can further include drying the produce in the produce bin using the dryer.

According to another case, the method 1600 can further include moving the transport device holding the empty produce bin to a bin conveyer along the predetermined path and setting down the empty produce bin on the bin conveyer. According to another case, the method 1600 can further include spraying the empty produce bin with a wash solution using a spraying device attached to the bin conveyer.

According to another case, the method 1600 can further include collecting system information from at least one of a plurality of information sources. The plurality of information sources includes one or more of a plurality of sensors distributed in the produce dryer system, a human machine interface (HMI), a controller, a server, and other components capable of collecting information.

According to another case, the produce drying system can include a plurality of transport devices that are each able to grab and move bins too and from the dryer and described above. Additionally, the plurality of transport devices is controlled such that they can avoid each other and operate efficiently as they move and select bins.

According to another case, a produce drying system includes independent sensors that can be attached to dryers, hoppers, conveyers, etc. that are already operating in a produce processing plant. The system also includes the transport device that is added in a space that provides enough maneuvering space for the transport device to travel between all elements of the system. This system also includes a communication and control module that can be located anywhere in the system. This system can be retrofitted to an already deployed dryer system by adding the sensors the already operating device along with placing the transport device and communication and control module. According to another case, the system can include all new dryers, hoppers, conveyers, transport device, etc. that have integrated sensors and a communication and control module.

According to one or more embodiments, a produce dryer system includes a pickup station including at least one bin filled with produce that is wet. The produce dryer system can also include a transport device. The transport device includes a chassis that travels along the ground on a predetermined path, a driven arm attached to the chassis that is configured to pick up and set down the at least one bin, and a controller that determines when to pick up the bin, when to set down the bin, where to move the chassis, and where to move the driven arm. The produce dryer system further includes a first dryer configured to receive the bin from the transport device and dry the produce in the bin by running for a dryer cycle associated with the produce and a second dryer configured to receive the bin from the transport device and dry the produce in the bin by running for the dryer cycle associated with the produce. The controller of the transport device determines which of the first dryer and the second dryer to use based on collected system information. The produce dryer system can also include, according to one or more embodiments, a hopper configured to receive the produce content from the bin.

According to one or more embodiments, the pickup station is an area where at least one bin is placed in a queue along with other bins to be dried. According to one or more embodiments, the at least one bin is a produce bin configured to hold produce, and produce includes leafy greens, vegetables, fruits, grains, and other consumable food items. According to one or more embodiments, the transport device is configured to deposit the produce content into the hopper by rotating the driven arm holding the bin when the transport device is positioned adjacent to the hopper.

According to one or more embodiments, the transport device is an automated guided vehicle (AGV). According to one or more embodiments, the transport device further includes a positioning sensor that provides data relating to the position of the transport device relative to other elements of the produce dryer system.

According to one or more embodiments, the transport device further includes a camera sensor configured to receive visual inputs that are processed to determine the transport device location relative to other elements of the produce dryer system.

According to one or more embodiments, the transport device further includes a propulsion system. The propulsion includes an electric motor disposed on the chassis and a rolling portion powered by the electric motor. According to one or more embodiments, the rolling portion is selected from a group consisting of a plurality of wheels, one or more slide pads, one or more magnetic propulsion pads, and a continuous track system. According to one or more embodiments, the continuous track system includes a synthetic rubber track reinforced with steel set within the synthetic rubber track.

According to one or more embodiments, the predetermined path is a variable vehicle path that includes directional changes that traverse between the other elements of the system. According to one or more embodiments, the produce dryer system includes a vehicle track that includes a raised portion that extends along the predetermined path. The chassis is guided along by the raised portion, and the predetermined path is defined by the vehicle track.

According to one or more embodiments, the predetermined path is defined by a set of programmable instructions that define the location of the path that the transport device can travel along. According to one or more embodiments, the predetermined path can be adjusted based on one or more of collected system information and user input.

According to one or more embodiments, the first dryer is configured to dry a specific produce product, and the second dryer is configured to dry a different produce product. According to one or more embodiments, the first dryer and the second dryer can adjust dryer settings based on information provided from the produce dryer system. According to one or more embodiments, the information includes one or more of produce type, produce volume, produce weight, and produce shape. According to one or more embodiments, the first dryer and the second dryer can adjust dryer settings based on information provided from the transport device, and the information includes one or more of produce type, produce volume, produce weight, and produce shape.

According to one or more embodiments, collected system information includes one or more of usage and availability information of the first dryer and the second dryer, dryer cycle time remaining, bin queue information, dryer location information, transport device location information, and produce information. Further, according to one or more embodiments, the produce information includes one or more of produce type, produce weight, produce volume, produce cut state, and dryer settings for select produce.

According to one or more embodiments, the system further includes a bin conveyer configured to receive the bin from the transport device after it has been emptied in the hopper. According to one or more embodiments, the system includes a bin spray system attached to the bin conveyer that sprays the bin with a cleaning solution. According to one or more embodiments, the cleaning solution is one selected from a group consisting of water, a chlorine solution, and other chemicals and chemical mixes.

According to one or more embodiments, the system includes a produce conveyer connected to the hopper that received the produce that has been dried and transports the produce to be further processed for packaging. According to one or more embodiments, the system includes a central programmable logic controller (PLC) configured to control the transport device and dryers base on the collected system information. According to one or more embodiments, the system includes a plurality of sensors that collect system information.

According to one or more embodiments, the plurality of sensors includes one or more from a group consisting of a temperature sensor, a weight sensor, a RFID sensor, an image sensor, a video sensor, a sound sensor, an array of positioning sensors, a piezo electronic sensor, and other sensors or combination thereof. According to one or more embodiments, the plurality of sensors includes sensors located at one or more locations from a group consisting of at the pickup station, at the transport device, at the first dryer, at the second dryer, at the hopper, at the conveyer, at the PLC, and in proximity of the produce dryer system.

According to one or more embodiments, the system includes a gated interlock system includes a fence and a plurality of gates along the fence. The plurality of gates each includes a locking mechanism. Further, the locking mechanisms are controlled based on the location of the transport device. Also, gates that are within a certain distance of the transport device are locked.

According to one or more embodiments, the produce dryer system, further includes a human machine interface (HMI) and a kiosk that includes the HMI, wherein the HMI is a touch screen. According to one or more embodiments, the kiosk further includes a central programmable logic controller (PLC) configured to control the transport device and dryers base on the collected system information.

According to one or more embodiments, a produce bin transport device includes a chassis that travels along the ground on a predetermined path from a bin pickup station to a produce hopper with one or more dryers there between, a driven arm attached to the chassis that is configured to pick up and set down a bin that is configured to contain produce, and a controller that determines when to pick up the bin, when to set down the bin, where to move the chassis, and where to move the driven arm. According to one or more embodiments, the produce bin transport device moves the bin from the pickup station to a dryer from the one or more dryers, and from the dryer to the produce hopper.

According to one or more embodiments, the produce bin transport device includes a positioning sensor that providing data relating to the position of the produce bin transport device relative to the pickup station, one or more dryers, and produce hopper. According to one or more embodiments, the produce bin transport device further includes a camera sensor configured to receive visual inputs that are processed to determine the produce bin transport device location relative to the pickup station, one or more dryers, and produce hopper. According to one or more embodiments, the produce bin transport device further includes a propulsion system. The propulsion system can include an electric motor disposed on the chassis, and a rolling portion powered by the electric motor. According to one or more embodiments, the rolling portion is selected from a group consisting of a plurality of wheels, one or more slide pads, one or more magnetic propulsion pads, and a continuous track system. According to one or more embodiments, the continuous track system includes a synthetic rubber track reinforced with steel set within the synthetic rubber track.

According to one or more embodiments, the produce bin transport device further includes a power cabling system that includes cabling that connects the transport device to an electric power source. According to one or more embodiments, the cabling folds back onto itself as the produce bin transport device moves closer to the electric power source.

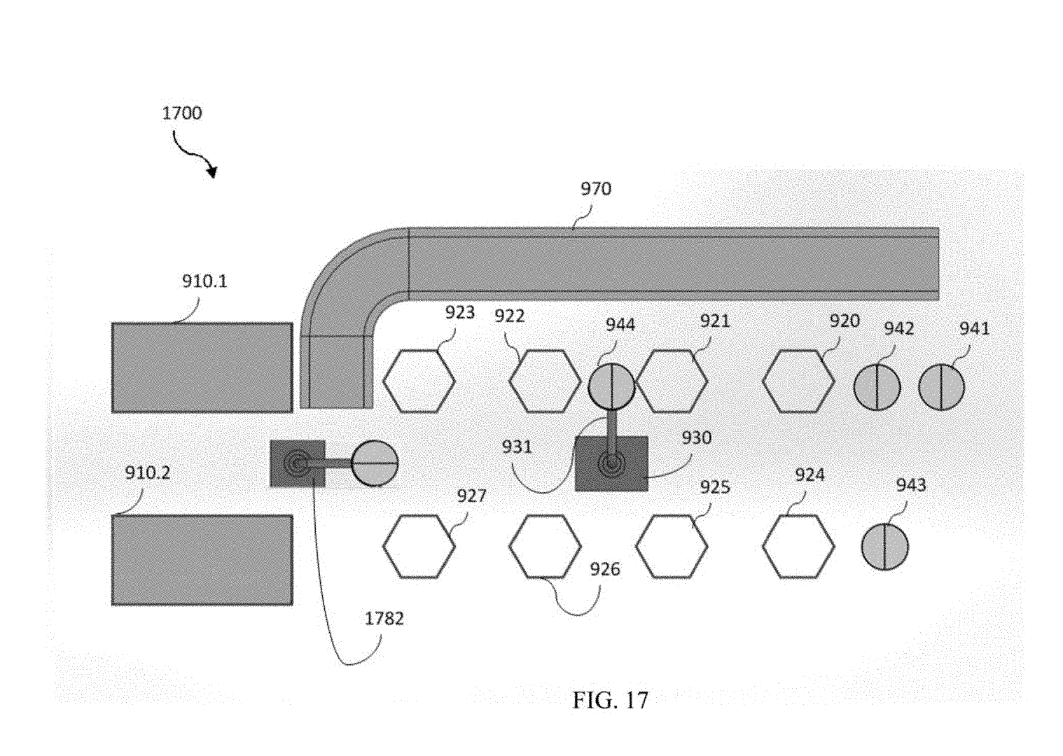

FIG. 17 illustrates a top view of a produce dryer system including a plurality of feature including a bin receiver 1782 in accordance with one or more embodiments.

Similar to FIG. 9, FIG. 17 includes a produce dryer system 900 including a plurality of features in accordance with one or more embodiments. As shown, the system 900 includes a first hopper 910.1 and as second hopper 910.2. The system 900 also includes a transport device 930. The transport device 930 includes an arm 931 that is configured to grab a dryer bin 944 from a group of dryer bins 941, 942, 943, and 944 that are initially placed in an area that is designated as a pickup station that can also be called a pickup area or zone. The system 900 also includes a return conveyer 970 for empty dryer bins. The system 900 further includes a plurality of dryers 920-927 that are arranged in two rows (a first row includes dryers 920, 921, 922, and 923 and a second row includes dryers 924, 925, 926, and 927) on either side of the transport device 930. As shown, the transport device 930 has open space that traverses the length of the system 900 within which the transport device 930 can travel to reach each of the other elements of the system 900.

As shown, the transport device 930 is in a position between dryers 921 and 922 holding the dryer bin 944. This positioning shows how the arm 931 of the transport device 930 is able to hold a dryer bin such that is can lift and lower the bin in and/or out of any of the dryers 920-927. The arm 931 can also rotate while holding the dryer bin 944 such that the dryer bin 944 can be placed or removed from one of the second row of dryers 924, 925, 926, and 927.

Further, once the bin is dried by one of the dryers, the transport device 930 can grab the bin and move it over one of the hoppers 910.1 and 910.2. The arm 931 can then rotate the bin depositing the contents of the bin into one of the hoppers 910.1 and 910.2. In another case, the bin 944 can receive a signal from the arm 931, transport device 930, or from another element of the system 900 that triggers the bin 944 to open and drop the contents within into one of the hoppers 910.1 and 910.2. In another case, the arm physically actuates a switch on the bin that causes the bin to open and release the contents.

Once the bin 944 is empty, the transport device 930 moves into a position adjacent to the return conveyer 970 and then rotates the arm 931 such that the bin 944 is above the return conveyer 970. The arm 931 can then lower and deposit the bin 944 onto the return conveyer 970. The return conveyer 970 can return the bin 944 to another location in the processing plant where it can be taken and filled again with wet produce and set within the pickup station. At this point, the system 900 can control the transport device 930 to queue up the newly filled bin for pickup up and drying.

Further, FIG. 17 includes a bin receiver 1782. The bin receiver 1782 may essentially be a second transport device that is limited to the area adjacent to the return conveyer 970 and hoppers 910.1 and 910.2. The bin receiver 1782 can be configured to accept at least one bin from the primary transport device 930. In another case, the bin receiver 1782 can accept all bins from the transport device 903. The bin receiver 1782 can then take that bin and load the produce from the bin into the hoppers 910.1 and 910.2 and then place the bin on the return conveyer 970. For example, as shown in FIG. 17 the bin receiver 782 would therefore be able to manage the bin to and from the hoppers 910.1 and 910.2 and to the bin return conveyer 970. This would provide the transport device 930 with more availability to the dryers.

According to another case, a transfer zone between the transport device 930 and the bin receiver 1782 may be provided. The transfer zone may include a bench like portion that can facilitate the hand-off between the transporters 930 and 1782. For example, the transport device 930 may travel to a point in proximity or within the transfer zone and deposit a bin in the transfer zone. The bin receiver 1782 can also travel to an adjacent point near or in the transfer zone such that the bin receiver 1782 can grab the deposited bin for further processing as discussed above. In another example, the transport device 930 may meet the bin receiver 1782 at the transfer zone and the bin may be rested on the bench portion in the transfer zone when the hand-off between the transporters 930 and 1782 is executed. This can facilitate the hand-off by not requiring the bin to be lowered or raised when handing off between the transporters. Additionally, this can provide a queue area so that neither transporter has to wait on the other.

In accordance with one or more embodiments as described above, it is important to note that the transport device 930 can, after depositing a bin in a dryer, move on and tend to other bins, dryer, hoppers, and/or other elements in the system when anyone bin is being dried.

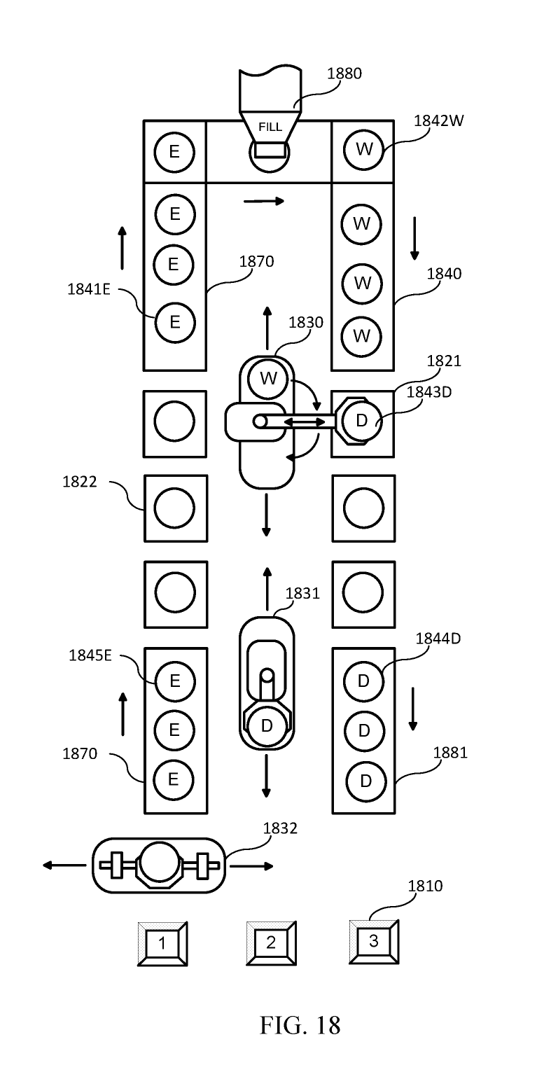

Further, in accordance with one or more embodiments, FIG. 18 illustrates another top view of a produce dryer system including a plurality of features in accordance with one or more embodiments. As shown, an empty bin area 1870 is provided that is configured to hold one or more empty bins 1841E. The empty bin area 1870 may be a platform with roll bars or a powered conveyer that can move the empty bins 1841E in a direction as shown toward a produce fill machine 1880. The produce fill machine 1880 is configured to deposit wet produce into a previously empty bin 1831E. A bin that is filled by the produce fill machine 1880 may be referred to as a filled wet bin 1842W that contains wet produce. A wet bin 1842W is provided in a wet bin area 1840 that can be a platform with roll bars or a powered conveyer that can move the wet bin 1842W in a direction away from the fill machine 1880.

The system may further include a number of transport devices that move bins along the ground to and from dryers and dumpsters and conveyers. For example, at this point, a first transport device 1830 may move into a position in proximity of a wet bin 1842W. The first transport device 1830 can use its retractable and rotatable arm to grab the bin 1842W and then move the move into a position over a dryer 1821. The first transport device 1830 may then place the bin 1842W into the dryer 1821 which can attend to drying the produce within the bin 1842W. A plurality of dryers may be provided that includes, for example, dryer 1822. Once the produce has been dried, the bin can be considered to be a filled dry bin 1843D that needs to be transported to a produce dumpster 1810 and then back to the empty bin area 1870. The bin 1843D can be moved toward the dumpster 1810 in a number of ways. For example, a second transport device 1831 can move into a position near the dryer 1821 and can then grab then bin 1843D. The second transport device 1831 can then move the bin 1843D and hand it off to a third transport device 1832 that is dedicated to dumping bins into dumpsters and then placing the empty bins back into the empty bin area 1870. Alternatively, the first transport device 1830 may initially grab the dry bin 1843D from the dryer 1821 and transport the bin to the second transport device 1831 and hand off the bin to the second transport device 1831 which can then proceed as described before. Further, the second transport device can place a dry bin 1844D that it is carrying in a queue in a dry bin area 1881. This may be done, for example, when the third transport device 1832 is unable to receive a bin. The third transport device 1832 can then pick up the dry bin 1844D from that area 1881 when it is ready and proceed to dump to produce into, for example, a dumpster 1810. Once empty, the third transport device may place that empty bin in the empty bin area 1870.

The empty bin area 1870 may be two areas as shown which uses some other mechanism to move the empty bins from the lower area back to the upper area to be filled again by the produce fill machine 1880. In some cases, the area 1870 may be a single conveyer that extends from the point where the third transport device 1832 deposits empty bins all the way back to the produce fill machine 1880. In another case, a fourth transport device may be provided that carries the empty bins from the lower area to the upper area.

One or more advancements, advantages, and/or benefits of one or more of the above embodiments include one or more of the following. The transport device eliminates the need to implement over hanging systems. This removal of the pully and rope system lowers the risk of moving bins in and out of dryers far safer. Also, the sensor and control abilities of the system provide additional benefits of accurate real-time data being provided to a user. Also, all elements of the system can also be controlled.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A produce dryer system, comprising:
a pickup station comprising a bin configured to contain produce that is designated for drying;
a first dryer and a second dryer configured to receive the bin and dry the produce in the bin by running for a dryer cycle associated with the produce; and
a transport device comprising:
a ground transport chassis configured to travel along a predetermined path;
a driven arm attached to the ground transport chassis that is configured to pick up and set down the bin; and
a controller configured to determine which of the first dryer or the second dryer to use for drying the produce in the bin and for positioning and removing the bin from the first dryer or second dryer with the transport device.

2. The produce dryer system of claim 1,
wherein the pickup station comprises a designated area to receive the bin within a queue of other bins, each bin containing produce that is designated for drying.

3. The produce dryer system of claim 1,
a hopper configured to receive the produce from the bin,
wherein the transport device is configured to deposit the produce into the hopper by driving the driven arm holding the bin when the transport device is positioned adjacent to the hopper.

4. The produce dryer system of claim 3,
wherein the transport device comprises a first transport device and a second transport device,
wherein the first transport device is configured to transport the bin from the pickup station to the first dryer and the second dryer, and
wherein the second transport device is configured to transport the bin from the first dryer and the second dryer to the hopper.

5. The produce dryer system of claim 1, wherein the transport device further comprises:
a positioning sensor that is configured to provide data relating to a position of the transport device relative to at least one of the first dryer, the second dryer, or the pickup station.

6. The produce dryer system of claim 1, further comprising:
a camera sensor configured to receive visual inputs that are processed to determine a location of the transport device relative to at least one of the first dryer, the second dryer, or the pickup station.

7. The produce dryer system of claim 1, wherein the transport device further comprises:
a propulsion system comprising:
an electric motor disposed on the chassis; and
a rolling portion powered by the electric motor,
wherein the rolling portion is selected from a group consisting of a plurality of wheels, one or more slide pads, one or more magnetic propulsion pads, and a continuous track system, and
wherein the continuous track system includes a synthetic rubber track reinforced with steel set within the synthetic rubber track.

8. The produce dryer system of claim 1, further comprising:
a vehicle track that includes a raised portion that extends along the predetermined path,
wherein the chassis is guided along by the raised portion, and
wherein the predetermined path is defined by the vehicle track.

9. The produce dryer system of claim 1,
wherein the predetermined path is defined by a set of programmable instructions that define a location of the predetermined path that the transport device travels along, and
wherein the predetermined path is configured to be adjusted based on one or more of collected system information and user input.

10. The produce dryer system of claim 1,
wherein the first dryer and the second dryer are configured to adjust dryer settings based on information provided from at least one of the first dryer, the transport device, or the pickup station, and
wherein the information includes one or more of produce type, produce volume, produce weight, produce cut state, or produce shape.

11. The produce dryer system of claim 1, further comprising:
a plurality of sensors that collect system information,
wherein the plurality of sensors includes one or more from a group consisting of a temperature sensor, a weight sensor, an RFID sensor, an image sensor, a video sensor, a sound sensor, an array of positioning sensors, and a piezo-electronic sensor,
wherein the plurality of sensors includes sensors located at one or more locations from a group consisting of at the pickup station, at the transport device, at the first dryer, at the second dryer, at a hopper, at a conveyer, at a programmable logic controller (PLC), and in proximity of the produce dryer system,
wherein the controller is configured to determine which of the first dryer or the second dryer to use based on collected system information, and
wherein collected system information includes one or more of usage and availability information of the first dryer and the second dryer, dryer cycle time remaining, bin queue information, dryer location information, transport device location information, or produce information.

12. The produce dryer system of claim 1, further comprising:
a bin conveyer configured to receive the bin from the transport device after the bin has emptied the produce into a hopper.

13. The produce dryer system of claim 11, further comprising:
a bin spray system attached to a bin conveyer that is configured to spray the bin with a cleaning solution,
wherein the cleaning solution is selected from a group consisting of water, a chlorine solution, and a produce wash solution.

14. The produce dryer system of claim 1, further comprising:
a produce conveyer connected to a hopper that is configured to receive the produce from the hopper and transport the produce for packaging.

15. The produce dryer system of claim 11, further comprising:
a central programmable logic controller (PLC) configured to control the transport device and dryers based on the collected system information.

16. The produce dryer system of claim 1, further comprising:
a gated interlock system comprising a fence and a plurality of gates along the fence,
wherein each of the gates comprises a locking mechanism,
wherein the locking mechanisms are controlled based on a location of the transport device such that the gates within a predetermined distance of the transport device are operated to lock.

17. A produce bin transport device, comprising:
a ground transport chassis configured to travel along a predetermined path from a bin pickup station to a produce hopper with one or more dryers therebetween;
a driven arm attached to the chassis and configured to pick up and set down a bin that contains produce; and
a controller configured to determine when to pick up the bin, when to set down the bin, where to move the chassis, and where to move the driven arm,
wherein the produce bin transport device is configured to move the bin from the pickup station to a dryer from the one or more dryers, and from the dryer to the produce hopper.

18. A method of operating a produce dryer system, the method comprising:
moving a transport device along a predetermined ground path to a pickup station;
picking up a produce bin from the pickup station with the transport device using a driven arm of the transport device that is attached to a chassis;
moving the produce pin along the predetermined path to a dryer with the transport device; and
positioning the produce bin into a dryer with the transport device.

19. The method of claim 18, further comprising:
removing the produce bin from the dryer with the transport device;
moving the produce bin adjacent a produce hopper with the transport device; and
depositing produce from the produce bin into the produce hopper with the transport device.

20. The method of claim 18, further comprising:
receiving the produce bin at the pickup station;
selecting the dryer from a plurality of dryers based on collected system information;
drying the produce in the produce bin using the dryer;
moving the transport device holding the empty produce bin to a bin conveyer along the predetermined path;
setting down the empty produce bin on the bin conveyer;
spraying the empty produce bin with a wash solution using a spraying device attached to the bin conveyer; and
collecting system information from at least one of a plurality of information sources,
wherein the plurality of information sources includes one or more of a plurality of sensors distributed in the produce dryer system, a human machine interface (HMI), a controller, and a server.
